(19) United States
(12) Patent Application Publication
(10) Pub. No.: US 2025/0261052 A1
(43) Pub. Date: Aug. 14, 2025

(54) APPARATUS, METHOD, AND COMPUTER PROGRAM

(71) Applicant: Nokia Technologies Oy, Espoo (FI)

(72) Inventors: Amaanat ALI, Espoo (FI); Anna PANTELIDOU, Antony (FR); Ahmad AWADA, Munich (DE)

(21) Appl. No.: 18/701,312

(22) PCT Filed: Sep. 16, 2022
(86) PCT No.: PCT/EP2022/075719

§ 371 Date: Apr. 15, 2024

(30) Foreign Application Priority Data
Oct. 15, 2021 (FI) 20216070

(51) Int. Cl. H04W 36/00; H04L 41/147; H04W 24/10

(52) U.S. Cl. CPC H04W 36/0055; H04L 41/147; H04W 24/10

(57) ABSTRACT

The disclosure relates to a target network node comprising at least one processor and at least one memory including computer code for one or more programs, the at least one memory and the computer code configured, with the at least one processor, to cause the target network node at least to: determine (1100) a prediction of an outcome of a network procedure involving a source network node and the target network node or a model of a target network node transfer function to compute a prediction of an outcome of the network procedure involving the source network node and the target network node; and provide (1102), to the source network node, the prediction or the model of the target network node transfer function

### FIELD OF THE DISCLOSURE

The present disclosure relates to an apparatus, a method, and a computer program for providing a prediction or a model of a target network node transfer function to compute a prediction and for using the prediction or the model of the target network node transfer function to compute the prediction in a communication system.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to an aspect there is provided a target network node comprising means for: determining a prediction of an outcome of a network procedure involving a source network node and the target network node or a model of a target network node transfer function to compute a prediction of an outcome of the network procedure involving the source network node and the target network node; and providing, to the source network node, the prediction or the model of the target network node transfer function.

Determining the prediction or a model of a target network node transfer function may be in response to: receiving, from the source network node, a request to provide a prediction or a model of a target network node transfer function; and/or receiving, from a training host, a prediction or a model of a target network node transfer function.

The network procedure involving the source network node and the target network node may be a handover procedure; or the network procedure involving the source network node and the target network node may be a dual connectivity procedure.

The apparatus may comprise means for: receiving, from the source network node, a request to prepare the network procedure involving the source network node and the target network node.

The request to prepare the network procedure involving the source network node and the target network node may comprise the request to provide a prediction or a model of a target network node transfer function.

The apparatus may comprise means for: providing, to the source network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The apparatus may comprise means for: sending, to a training host, a request to provide the model of the target network node transfer function; receiving, from the training host, the model of the target network node transfer function.

The training host may be part of the target network node or separate from the target network node.

The training host may be configured to compute the model of the target network node transfer function based on user equipment capability received by the target training node and user equipment configuration generated by the target training node over time; and/or the training host may use a deep neural network.

The apparatus may comprise means for: determining that the prediction or the model of the target network node transfer function is no longer up to date; and provide, to the source network node, an up-to-date prediction or model of the target network node transfer function.

The prediction or the model of the target network node transfer function may be for a single user equipment or for a group of user equipments or for a plurality of groups of user equipments.

According to an aspect there is provided a target network node comprising at least one processor and at least one memory including computer code for one or more programs, the at least one memory and the computer code configured, with the at least one processor, to cause the apparatus at least to: determine a prediction of an outcome of a network procedure involving a source network node and the target network node or a model of a target network node transfer function to compute a prediction of an outcome of the network procedure involving the source network node and the target network node; and provide, to the source network node, the prediction or the model of the target network node transfer function.

Determining the prediction or a model of a target network node transfer function may be in response to: receiving, from the source network node, a request to provide a prediction or a model of a target network node transfer function; and/or receiving, from a training host, a prediction or a model of a target network node transfer function.

The network procedure involving the source network node and the target network node may be a handover procedure; or the network procedure involving the source network node and the target network node may be a dual connectivity procedure.

The at least one memory and the computer code may be configured, with the at least one processor, to cause the target network node at least to: receive, from the source network node, a request to prepare the network procedure involving the source network node and the target network node.

The request to prepare the network procedure involving the source network node and the target network node may comprise the request to provide a prediction or a model of a target network node transfer function.

The at least one memory and the computer code may be configured, with the at least one processor, to cause the target network node at least to: provide, to the source network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The at least one memory and the computer code may be configured, with the at least one processor, to cause the target network node at least to: send, to a training host, a request to provide the model of the target network node transfer function; receive, from the training host, the model of the target network node transfer function.

The training host may be part of the target network node or separate from the target network node.

The training host may be configured to compute the model of the target network node transfer function based on user equipment capability received by the target training node and user equipment configuration generated by the target training node over time; and/or the training host may use a deep neural network.

The at least one memory and the computer code may be configured, with the at least one processor, to cause the target network node at least to: determine that the prediction or the model of the target network node transfer function is no longer up to date; and provide, to the source network node, an up-to-date prediction or model of the target network node transfer function.

The prediction or the model of the target network node transfer function may be for a single user equipment or for a group of user equipments or for a plurality of groups of user equipments.

According to an aspect there is provided a target network node comprising circuitry configured to determine a prediction of an outcome of a network procedure involving a source network node and the target network node or a model of a target network node transfer function to compute a prediction of an outcome of the network procedure involving the source network node and the target network node; and provide, to the source network node, the prediction or the model of the target network node transfer function.

Determining the prediction or a model of a target network node transfer function may be in response to: receiving, from the source network node, a request to provide a prediction or a model of a target network node transfer function; and/or receiving, from a training host, a prediction or a model of a target network node transfer function.

The network procedure involving the source network node and the target network node may be a handover procedure; or the network procedure involving the source network node and the target network node may be a dual connectivity procedure.

The apparatus may comprise circuitry configured to: receive, from the source network node, a request to prepare the network procedure involving the source network node and the target network node.

The request to prepare the network procedure involving the source network node and the target network node may comprise the request to provide a prediction or a model of a target network node transfer function.

The apparatus may comprise circuitry configured to: provide, to the source network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The apparatus may comprise circuitry configured to: send, to a training host, a request to provide the model of the target network node transfer function; receive, from the training host, the model of the target network node transfer function.

The training host may be part of the target network node or separate from the target network node.

The training host may be configured to compute the model of the target network node transfer function based on user equipment capability received by the target training node and user equipment configuration generated by the target training node over time; and/or the training host may use a deep neural network.

The apparatus may comprise circuitry configured to: determine that the prediction or the model of the target network node transfer function is no longer up to date; and provide, to the source network node, an up-to-date prediction or model of the target network node transfer function.

The prediction or the model of the target network node transfer function may be for a single user equipment or for a group of user equipments or for a plurality of groups of user equipments.

According to an aspect there is provided a method comprising: determining a prediction of an outcome of a network procedure involving a source network node and a target network node or a model of a target network node transfer function to compute a prediction of an outcome of the network procedure involving the source network node and the target network node; and providing, to the source network node, the prediction or the model of the target network node transfer function.

The method may be performed by the target network node.

Determining the prediction or a model of a target network node transfer function may be in response to: receiving, from the source network node, a request to provide a prediction or a model of a target network node transfer function; and/or receiving, from a training host, a prediction or a model of a target network node transfer function.

The network procedure involving the source network node and the target network node may be a handover procedure; or the network procedure involving the source network node and the target network node may be a dual connectivity procedure.

The method may comprise: receiving, from the source network node, a request to prepare the network procedure involving the source network node and the target network node.

The request to prepare the network procedure involving the source network node and the target network node may comprise the request to provide a prediction or a model of a target network node transfer function.

The method may comprise: providing, to the source network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The method may comprise: sending, to a training host, a request to provide the model of the target network node transfer function; receiving, from the training host, the model of the target network node transfer function.

The training host may be part of the target network node or separate from the target network node.

The training host may be configured to compute the model of the target network node transfer function based on user equipment capability received by the target training node and user equipment configuration generated by the target training node over time; and/or the training host may use a deep neural network.

The method may comprise: determining that the prediction or the model of the target network node transfer function is no longer up to date; and provide, to the source network node, an up-to-date prediction or model of the target network node transfer function.

The prediction or the model of the target network node transfer function may be for a single user equipment or for a group of user equipments or for a plurality of groups of user equipments.

According to an aspect there is provided a computer program comprising computer executable code which when run on at least one processor is configured to: determine a prediction of an outcome of a network procedure involving a source network node and a target network node or a model of a target network node transfer function to compute a prediction of an outcome of the network procedure involving the source network node and the target network node; and provide, to the source network node, the prediction or the model of the target network node transfer function.

The at least one processor may be part of the target network node.

Determining the prediction or a model of a target network node transfer function may be in response to: receiving, from the source network node, a request to provide a prediction or a model of a target network node transfer function; and/or receiving, from a training host, a prediction or a model of a target network node transfer function.

The network procedure involving the source network node and the target network node may be a handover procedure; or the network procedure involving the source network node and the target network node may be a dual connectivity procedure.

The computer program may comprise computer executable code which when run on at least one processor is configured to: receive, from the source network node, a request to prepare the network procedure involving the source network node and the target network node.

The request to prepare the network procedure involving the source network node and the target network node may comprise the request to provide a prediction or a model of a target network node transfer function.

The computer program may comprise computer executable code which when run on at least one processor is configured to: provide, to the source network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The computer program may comprise computer executable code which when run on at least one processor is configured to: send, to a training host, a request to provide the model of the target network node transfer function; receive, from the training host, the model of the target network node transfer function.

The training host may be part of the target network node or separate from the target network node.

The training host may be configured to compute the model of the target network node transfer function based on user equipment capability received by the target training node and user equipment configuration generated by the target training node over time; and/or the training host may use a deep neural network.

The computer program may comprise computer executable code which when run on at least one processor is configured to: determine that the prediction or the model of the target network node transfer function is no longer up to date; and provide, to the source network node, an up-to-date prediction or model of the target network node transfer function.

The prediction or the model of the target network node transfer function may be for a single user equipment or for a group of user equipments or for a plurality of groups of user equipments.

According to an aspect there is provided a source network node comprising means for: sending, to a target network node, a request to provide a prediction of an outcome of a network procedure involving the source network node and the target network node or a model of a target network node transfer function to compute a prediction of an outcome of a network procedure involving a source network node and the target network node; receiving, from the target network node, a prediction or a model of the target network node transfer function; and determining to perform the network procedure involving the source network node and the target network node based on the prediction of or the model of the target network node transfer function.

The apparatus may comprise means for: storing, the prediction or a model of the target network node transfer function.

The network procedure involving the source network node and the target network node may be a handover procedure; or the network procedure involving the source network node and the target network node may be a dual connectivity procedure.

The apparatus may comprise means for: sending, to the target network node, a request to prepare the network procedure involving the source network node and the target network node.

The request to prepare the network procedure involving the source network node and the target network node may comprise a request to provide the prediction or the model of the target network node transfer function.

The apparatus may comprise means for: receiving, from the target network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The apparatus may comprise means for: receiving, from the target network node, an up-to-date prediction or an up-to-date model of the target network node transfer function.

Determining to prepare the network procedure involving the source network node and the target network node based on the model of the target network node transfer function comprises: receiving, from a user equipment, user equipment capability; determining a prediction of an outcome of network procedure involving a source network node and the target network node based on the model of the target network node transfer function; and determining to perform the network procedure involving the source network node and the target network node based on the prediction.

The apparatus may comprise means for: sending, to the target network node, a request to prepare the network procedure involving the source network node and the target network node, wherein the request to prepare the network procedure involving the source network node and the target network node comprises an identifier of the prediction or the model of the target network node transfer function.

The apparatus may comprise means for: providing, to the target network node, a subsequent prediction of an outcome of another network procedure involving the source network node and the target network node or a model of the target network node transfer function to compute a subsequent prediction of an outcome of another network procedure involving the source network node and the target network node.

Providing, to the target network node, the prediction or the model of the source network node transfer function may be in response to: receiving, from the target network node, the prediction or the model of the target network node transfer function; receiving, from the target network node, a one-shot pull request to provide the subsequent prediction or the model of the source network node transfer function; or receiving, from the target network node, a periodic pull request to provide the subsequent prediction or the model of the source network node transfer function.

The prediction indicator may comprise at least one of one or more values in an interval [0,1] for one or more key performance indicators, a joint value in an interval [0,1] for one or more key performance indicators, a binary value that indicates success or failure, a soft value or a time indicating until when the prediction indicator will be valid.

According to an aspect there is provided a source network node comprising at least one processor and at least one memory including computer code for one or more programs, the at least one memory and the computer code configured, with the at least one processor, to cause the apparatus at least to: send, to a target network node, a request to provide a prediction of an outcome of a network procedure involving the source network node and the target network node or a model of a target network node transfer function to compute a prediction of an outcome of a network procedure involving a source network node and the target network node; receive, from the target network node, a prediction or a model of the target network node transfer function; and determine to perform the network procedure involving the source network node and the target network node based on the prediction of or the model of the target network node transfer function.

The at least one memory and the computer code may be configured, with the at least one processor, to cause the source network node at least to: store, the prediction or a model of the target network node transfer function.

The network procedure involving the source network node and the target network node may be a handover procedure; or the network procedure involving the source network node and the target network node may be a dual connectivity procedure.

The at least one memory and the computer code may be configured, with the at least one processor, to cause the source network node at least to: send, to the target network node, a request to prepare the network procedure involving the source network node and the target network node.

The request to prepare the network procedure involving the source network node and the target network node may comprise a request to provide the prediction or the model of the target network node transfer function.

The at least one memory and the computer code may be configured, with the at least one processor, to cause the target network node at least to: receive, from the target network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The at least one memory and the computer code may be configured, with the at least one processor, to cause the source network node at least to: receive, from the target network node, an up-to-date prediction or an up-to-date model of the target network node transfer function.

Determining to prepare the network procedure involving the source network node and the target network node based on the model of the target network node transfer function comprises: receiving, from a user equipment, user equipment capability; determining a prediction of an outcome of network procedure involving a source network node and the target network node based on the model of the target network node transfer function; and determining to perform the network procedure involving the source network node and the target network node based on the prediction.

The at least one memory and the computer code may be configured, with the at least one processor, to cause the source network node at least to: send, to the target network node, a request to prepare the network procedure involving the source network node and the target network node, wherein the request to prepare the network procedure involving the source network node and the target network node comprises an identifier of the prediction or the model of the target network node transfer function.

The at least one memory and the computer code may be configured, with the at least one processor, to cause the source network node at least to: provide, to the target network node, a subsequent prediction of an outcome of another network procedure involving the source network node and the target network node or a model of the target network node transfer function to compute a subsequent prediction of an outcome of another network procedure involving the source network node and the target network node.

Providing, to the target network node, the prediction or the model of the source network node transfer function may be in response to: receiving, from the target network node, the prediction or the model of the target network node transfer function; receiving, from the target network node, a one-shot pull request to provide the subsequent prediction or the model of the source network node transfer function; or receiving, from the target network node, a periodic pull request to provide the subsequent prediction or the model of the source network node transfer function.

The prediction indicator may comprise at least one of one or more values in an interval [0,1] for one or more key performance indicators, a joint value in an interval [0,1] for one or more key performance indicators, a binary value that indicates success or failure, a soft value or a time indicating until when the prediction indicator will be valid.

According to an aspect there is provided a source network node comprising circuitry configured to: send, to a target network node, a request to provide a prediction of an outcome of a network procedure involving the source network node and the target network node or a model of a target network node transfer function to compute a prediction of an outcome of a network procedure involving a source network node and the target network node; receive, from the target network node, a prediction or a model of the target network node transfer function; and determine to perform the network procedure involving the source network node and the target network node based on the prediction of or the model of the target network node transfer function.

The apparatus may comprise circuitry configured to: store, the prediction or a model of the target network node transfer function.

The network procedure involving the source network node and the target network node may be a handover procedure; or the network procedure involving the source network node and the target network node may be a dual connectivity procedure.

The apparatus may comprise circuitry configured to: send, to the target network node, a request to prepare the network procedure involving the source network node and the target network node.

The request to prepare the network procedure involving the source network node and the target network node may comprise a request to provide the prediction or the model of the target network node transfer function.

The apparatus may comprise circuitry configured to: receive, from the target network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The apparatus may comprise circuitry configured to: receive, from the target network node, an up-to-date prediction or an up-to-date model of the target network node transfer function.

Determining to prepare the network procedure involving the source network node and the target network node based on the model of the target network node transfer function comprises: receiving, from a user equipment, user equipment capability; determining a prediction of an outcome of network procedure involving a source network node and the target network node based on the model of the target network node transfer function; and determining to perform the network procedure involving the source network node and the target network node based on the prediction.

The apparatus may comprise circuitry configured to: send, to the target network node, a request to prepare the network procedure involving the source network node and the target network node, wherein the request to prepare the network procedure involving the source network node and the target network node comprises an identifier of the prediction or the model of the target network node transfer function.

The apparatus may comprise circuitry configured to: provide, to the target network node, a subsequent prediction of an outcome of another network procedure involving the source network node and the target network node or a model of the target network node transfer function to compute a subsequent prediction of an outcome of another network procedure involving the source network node and the target network node.

Providing, to the target network node, the prediction or the model of the source network node transfer function may be in response to: receiving, from the target network node, the prediction or the model of the target network node transfer function; receiving, from the target network node, a one-shot pull request to provide the subsequent prediction or the model of the source network node transfer function; or receiving, from the target network node, a periodic pull request to provide the subsequent prediction or the model of the source network node transfer function.

The prediction indicator may comprise at least one of one or more values in an interval [0,1] for one or more key performance indicators, a joint value in an interval [0,1] for one or more key performance indicators, a binary value that indicates success or failure, a soft value or a time indicating until when the prediction indicator will be valid.

According to an aspect there is provided a method comprising: sending, to a target network node, a request to provide a prediction of an outcome of a network procedure involving a source network node and the target network node or a model of a target network node transfer function to compute a prediction of an outcome of a network procedure involving a source network node and the target network node; receiving, from the target network node, a prediction or a model of the target network node transfer function; and determining to perform the network procedure involving the source network node and the target network node based on the prediction of or the model of the target network node transfer function.

The method may be performed by the source network node.

The method may comprise: storing, the prediction or a model of the target network node transfer function.

The network procedure involving the source network node and the target network node may be a handover procedure; or the network procedure involving the source network node and the target network node may be a dual connectivity procedure.

The method may comprise: sending, to the target network node, a request to prepare the network procedure involving the source network node and the target network node.

The request to prepare the network procedure involving the source network node and the target network node may comprise a request to provide the prediction or the model of the target network node transfer function.

The method may comprise: receiving, from the target network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The method may comprise: receiving, from the target network node, an up-to-date prediction or an up-to-date model of the target network node transfer function.

Determining to prepare the network procedure involving the source network node and the target network node based on the model of the target network node transfer function comprises: receiving, from a user equipment, user equipment capability; determining a prediction of an outcome of network procedure involving a source network node and the target network node based on the model of the target network node transfer function; and determining to perform the network procedure involving the source network node and the target network node based on the prediction.

The method may comprise: sending, to the target network node, a request to prepare the network procedure involving the source network node and the target network node, wherein the request to prepare the network procedure involving the source network node and the target network node comprises an identifier of the prediction or the model of the target network node transfer function.

The method may comprise: providing, to the target network node, a subsequent prediction of an outcome of another network procedure involving the source network node and the target network node or a model of the target network node transfer function to compute a subsequent prediction of an outcome of another network procedure involving the source network node and the target network node.

Providing, to the target network node, the prediction or the model of the source network node transfer function may be in response to: receiving, from the target network node, the prediction or the model of the target network node transfer function; receiving, from the target network node, a one-shot pull request to provide the subsequent prediction or the model of the source network node transfer function; or receiving, from the target network node, a periodic pull request to provide the subsequent prediction or the model of the source network node transfer function.

The prediction indicator may comprise at least one of one or more values in an interval [0,1] for one or more key performance indicators, a joint value in an interval [0,1] for one or more key performance indicators, a binary value that indicates success or failure, a soft value or a time indicating until when the prediction indicator will be valid.

According to an aspect there is provided a computer program comprising computer executable code which when run on at least one processor is configured to: send, to a target network node, a request to provide a prediction of an outcome of a network procedure involving a source network node and the target network node or a model of a target network node transfer function to compute a prediction of an outcome of a network procedure involving a source network node and the target network node; receive, from the target network node, a prediction or a model of the target network node transfer function; and determine to perform the network procedure involving the source network node and the target network node based on the prediction of or the model of the target network node transfer function.

The at least one processor may be part of the source network node.

The computer program may comprise computer executable code which when run on at least one processor is configured to: store, the prediction or a model of the target network node transfer function.

The network procedure involving the source network node and the target network node may be a handover procedure; or the network procedure involving the source network node and the target network node may be a dual connectivity procedure.

The computer program may comprise computer executable code which when run on at least one processor is configured to: send, to the target network node, a request to prepare the network procedure involving the source network node and the target network node.

The request to prepare the network procedure involving the source network node and the target network node may comprise a request to provide the prediction or the model of the target network node transfer function.

The computer program may comprise computer executable code which when run on at least one processor is configured to: receive, from the target network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The computer program may comprise computer executable code which when run on at least one processor is configured to: receive, from the target network node, an up-to-date prediction or an up-to-date model of the target network node transfer function.

Determining to prepare the network procedure involving the source network node and the target network node based on the model of the target network node transfer function comprises: receiving, from a user equipment, user equipment capability;

determining a prediction of an outcome of network procedure involving a source network node and the target network node based on the model of the target network node transfer function; and determining to perform the network procedure involving the source network node and the target network node based on the prediction.

The computer program may comprise computer executable code which when run on at least one processor is configured to: send, to the target network node, a request to prepare the network procedure involving the source network node and the target network node, wherein the request to prepare the network procedure involving the source network node and the target network node comprises an identifier of the prediction or the model of the target network node transfer function.

The computer program may comprise computer executable code which when run on at least one processor is configured to: provide, to the target network node, a subsequent prediction of an outcome of another network procedure involving the source network node and the target network node or a model of the target network node transfer function to compute a subsequent prediction of an outcome of another network procedure involving the source network node and the target network node.

Providing, to the target network node, the prediction or the model of the source network node transfer function may be in response to: receiving, from the target network node, the prediction or the model of the target network node transfer function; receiving, from the target network node, a one-shot pull request to provide the subsequent prediction or the model of the source network node transfer function; or receiving, from the target network node, a periodic pull request to provide the subsequent prediction or the model of the source network node transfer function.

The prediction indicator may comprise at least one of one or more values in an interval [0,1] for one or more key performance indicators, a joint value in an interval [0,1] for one or more key performance indicators, a binary value that indicates success or failure, a soft value or a time indicating until when the prediction indicator will be valid.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AMF: Access and Mobility Management Function
API: Application Programming Interface
BS: Base Station
CU: Centralized Unit
DL: Downlink
DU: Distributed Unit
gNB: gNodeB
GSM: Global System for Mobile communication
HO: Handover
HSS: Home Subscriber Server
IoT: Internet of Things
IP: Internet Protocol
LTE: Long Term Evolution
MAC: Medium Access Control
MS: Mobile Station
MTC: Machine Type Communication
NEF: Network Exposure Function
NF: Network Function
NR: New radio
NRF: Network Repository Function
OAM: Operations Administration and Maintenance
PDU: Packet Data Unit
RAM: Random Access Memory
(R)AN: (Radio) Access Network
ROM: Read Only Memory
RRC: Radio Resource Control
SMF: Session Management Function
SRC: Source
TR: Technical Report
TS: Technical Specification
UE: User Equipment
UMTS: Universal Mobile Telecommunication System
VLAN: Virtual Local Area Network
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a signaling diagram of a handover procedure from a source network node to a target network node as per TS 38.300 (FIG. 9.2.3.1-1);

FIG. 5 shows a schematic representation of a method for generating UE configuration performed by a target network node;

FIG. 6 shows a schematic representation of a method for providing a model of a target network node transfer function;

FIG. 7 shows a schematic representation of a method for using a model of a target network node transfer function;

FIG. 8 shows a signaling diagram of a process combining a method for providing a model of a target network node transfer function and a method for using the model of the target network node transfer function;

FIGS. 9a and 9b show a signaling diagram of a process for providing a prediction or a model of a target network node transfer function to compute a prediction;

FIGS. 10a and 10b shows a signaling diagram of a process for using a prediction or a model of a target network node transfer function to compute a prediction;

FIG. 11 shows a signaling diagram of a process for a process for providing a prediction for a group of user equipment when a network procedure involving a source network node and a target network node is performed, wherein the process implements a push mechanism.

FIG. 12 shows a signalling diagram of a process for providing a prediction for a group of user equipments when a network procedure involving a source network node and a target network node is performed, wherein the process implements a one shot pull mechanism.

FIG. 13 shows a signalling diagram of a process for providing a prediction for a group of user equipments when a network procedure involving a source network node and a target network node is performed, wherein the process implements a periodic pull mechanism;

FIG. 14 shows a block diagram of a method for providing a prediction or a model of a target network node transfer function to compute a prediction;

FIG. 15 shows a block diagram of a method for providing a prediction or a model of a target network node transfer function to compute a prediction and for using the prediction or the model of a target network node transfer function; and

FIG. 16 shows a schematic representation of a non-volatile memory medium storing instructions which when executed by a processor allow a processor to perform one or more of the steps of the methods of FIGS. 14 and 15.

### DETAILED DESCRIPTION OF THE FIGURES

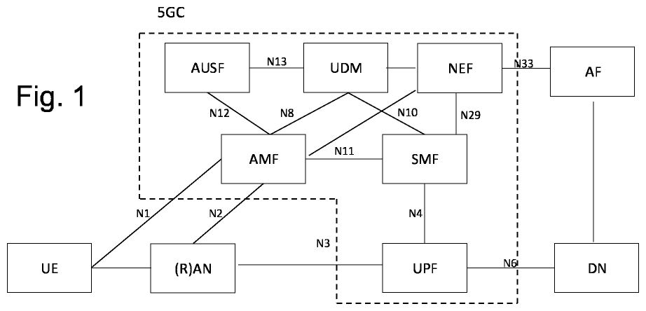

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprise a terminal, a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise an access and mobility management function (AMF), a session management function (SMF), an authentication server function (AUSF), a user data management (UDM), a user plane function (UPF) and/or a network exposure function (NEF).

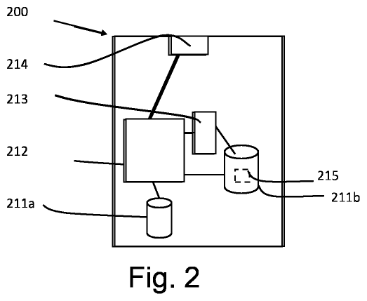

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

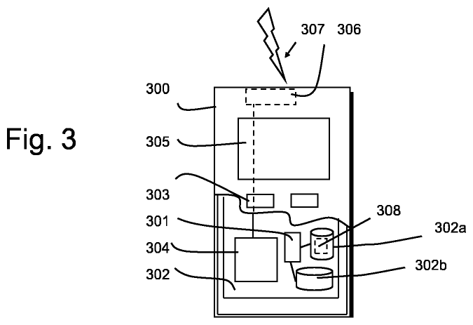

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capability, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304.

The device may optionally have a user interface such as keypad 305, touch sensitive screen or pad, combinations thereof or the like. Optionally one or more of a display, a speaker and a microphone may be provided depending on the type of the device.

Future 5GS may have to cater to an extremely diverse range of applications and may demand flexible networks with large number of control parameters. This may lead to intractable network control problems.

Machine learning may enable experimental data research by uncovering correlations and feature extraction on Big Data. Specifically, Machine learning can handle big amounts of any type of data in very efficient ways unlike traditional systems we have seen in the past. Machine learning may also allow hierarchical feature extraction from raw data with vast amounts of heterogenous data exhibiting complex correlations saving tremendous effort of hand-crafted feature engineering. Machine learning applied to mobile and wireless communication systems is a useful and insightful way of fundamentally thinking the design of these mobile and wireless communications systems.

One or more aspects of this disclosure relate to using artificial intelligence and/or machine learning based techniques to learn the “footprint” of a network node to allow for intelligent prediction of network and/or UE performance by another network node.

In this disclosure a network node may be a cellular network node (e.g. gNB) or a 5GC network node or a wireless network node (e.g. access point).

The configuration of a network node (e.g. gNB) may be performed by an operator. The operator may select a set of features for each cell managed by the network node. Additionally or alternatively, the configuration of the network node (e.g. gNB) may be performed by an operations administration and maintenance (OAM).

The network node (e.g. gNB) may receive UE capability from a UE on a radio resource control (RRC) interface. The UE capability may comprise non-access stratum capability. The UE capability may comprise access stratum or radio capability.

The UE non-access stratum capability may comprise supported algorithm for encryption and integrity (e.g. evolved packet system encryption algorithm and evolved packet system integrity algorithm), supported features like cellular internet of things, proximity service (e.g. device to device), dual connectivity support with NR (for LTE network), support for internet protocol multimedia subsystem voice, specific location based services, support of slicing or other.

The UE access stratum or radio capability may comprise Physical layer related band/band combinations, carrier aggregation related capabilities, supported modulations (e.g. 1024 or 256 quadrature amplitude modulation), channel bandwidths for FR1 and FR2, sub-carrier spacing, medium access control layer related capabilities (e.g. configured grant, uplink skipping, DRX, power headroom reporting, logical channel prioritization or capabilities of each feature the UE supports for the described feature capabilities in TS 38.306. The UE access stratum/radio capability signalling may be described in TS 38.331 which described how the UE signals its capabilities in different structures where each capability parameter is defined per UE, per duplex mode (FDD/TDD), per frequency range (FR1/FR2), per band, per band combinations. Some capability parameters are always defined per UE (e.g. SDAP, PDCP and RLC parameters) while some other not always (e.g. MAC and Physical Layer Parameters). The UE access stratum/radio capability may comprise tens of thousands of octets of information (e.g. typically 20 k-30 k going upwards to even 75 k-80 k octets for a powerful UE supporting most/all of the features in the specifications.

The network node (e.g. gNB) may decode the UE capability and generate a UE configuration. The UE configuration may comprise UE non-access stratum configuration. The UE configuration may comprise UE access stratum or radio configuration.

The UE non-access stratum configuration may comprise non-access stratum security mode command or procedures described in TS 23.502 and TS 24.501 (e.g., registration accept which configures the UE with a 5G temporary mobile subscriber identity, then a packet data unit session is established (i.e. configured) to the UE in a service request).

The UE access stratum/radio configuration may comprise conditional configuration (e.g. for conditional handover), dual connectivity configuration (e.g. for dual connectivity establishment), a conditional PSCell addition or change configuration (e.g. for dual connectivity establishment and secondary cell mobility), a carrier aggregation UE configuration, a multiple input multiple output UE configuration, a beamforming UE configuration, a bandwidth part UE configuration, a channel bandwidth UE configuration, a subcarrier UE configuration or other UE configuration. The network node (e.g. gNB) may provide the UE configuration to the UE on a RRC interface.

The UE configuration may be UE specific. The network node (e.g. gNB) may serve different UEs with different features (e.g. UE models (identified by a radio capability ID or otherwise), UE service specific types such as vehicle to everything, device to device, internet of things, ultra-reliable and low latency communication or UE network slices). The UE configuration may be different for the different UEs.

The UE configuration may be cell specific. The network node (e.g. gNB) may serve different cells with different features (e.g. carrier aggregation, FR2 specific operation, mobility features such as conditional handover or other). The UE configuration may be different for the different cells.

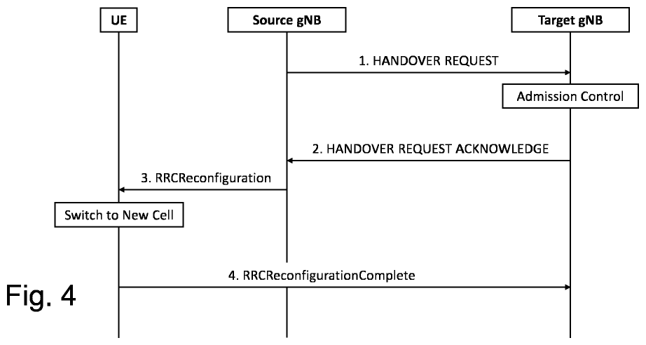

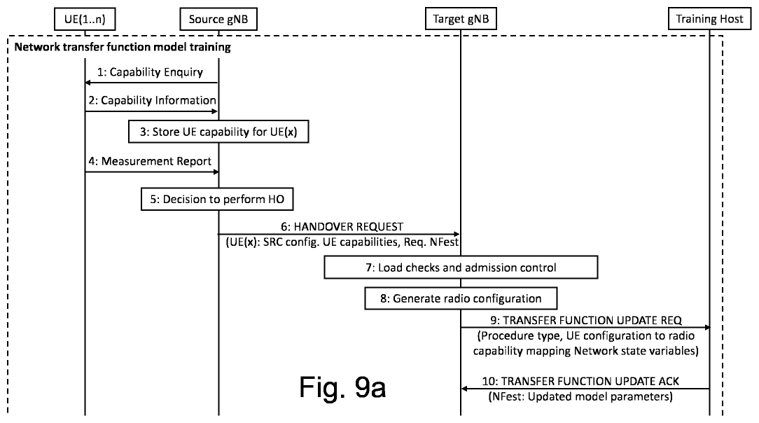

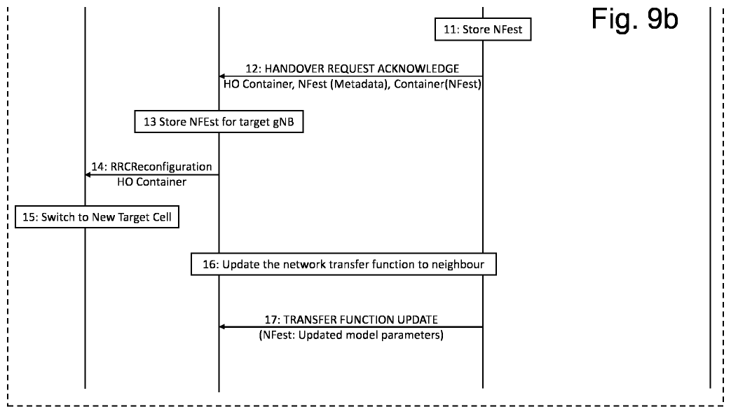

FIG. 4 shows a signaling diagram of a handover procedure from a source network node (e.g. source gNB) to a target network node (e.g. target gNB) as per TS 38.300 (FIG. 9.2.3.1-1).

A source network node (e.g. source gNB) may send a handover request to a target network node (e.g. target gNB) to request a handover of a UE from the source network node (e.g. source gNB) to the target network node (e.g. target gNB).

As part of a handover preparation process, the target network node (e.g. target gNB) may inspect a UE configuration provided by the source network node (e.g. source gNB) and a UE capability. The target network node (e.g. target gNB) may generate a UE configuration that could be provided by the target network node (e.g. target gNB). The UE configuration that could be provided by the target network node (e.g. target gNB) may be based on features of cells served by the target network node (e.g. target gNB) and/or time dependent factors of cells served by the target network node (e.g. target gNB) (e.g. load, congestion, power saving profile or other).

The UE configuration that could be provided by the target network node (e.g. target gNB) may be provided by the target network node (e.g. target gNB) to the source network node (e.g. source gNB) as part of a handover acknowledgement message.

The source network node (e.g. source gNB) may provide the UE configuration that could be provided by the target network node (e.g. target gNB) to the UE so as to allow the UE to access a cell served by the target network node (e.g. target gNB).

As such only upon receipt of the handover acknowledgement message the source network node (e.g. source gNB) may determine whether the target network node (e.g. target gNB) accepted the handover request.

A problem arising from the handover procedure in TS 38.300 is that it may not allow the source network node (e.g. source gNB) to predict (i.e. before sending the handover request message) the UE configuration that could be provided by the target network node (e.g. target gNB) to the UE and therefore to anticipate if a handover from the network node (e.g. source gNB) to the target network node (e.g. target gNB) will fail.

One or more aspects of this disclosure provide techniques to allow a source network node (e.g. source gNB) to predict (i.e. before sending the handover request message) the UE configuration that could be provided by the target network node (e.g. target gNB) to the UE.

One or more aspects of this disclosure provide techniques to allow a source network node (e.g. source gNB) to predict (i.e. before sending the handover request message) if the UE configuration that could be provided by the target network node (e.g. target gNB) to the UE will maintain some or all of UE configuration provided by the source network node (e.g. source gNB) to ensure a quality of a key performance indicator or a weighted set of a plurality of key performance indicators during handover.

The UE capability may comprise a large amount of information (e.g. several tens of kilobytes worth of band and feature set combinations). The UE capability may allow the source network node (e.g. source gNB) and/or the target network node (e.g. target gNB) to generate the UE configuration. The source network node (e.g. source gNB) and/or the target network node (e.g. target gNB) may provide the UE configuration to the UE via a user specific reconfiguration message.

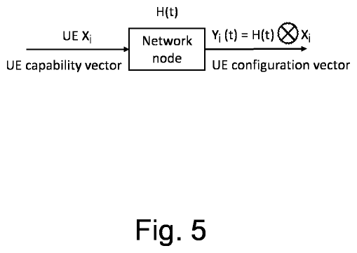

The UE configuration may be mathematically viewed as a convolution of the UE capability and a network node transfer function (source node (e.g. source gNB) and/or a target node (e.g. target gNB)) as illustrated on FIG. 5.

The UE capability may comprise static components, semi-static components and/or dynamic components (e.g. vary only in specific situations such as overheating).

The source network node (e.g. source gNB) and/or the target network node (e.g. target gNB) transfer function may model the generation of the UE configuration by the source network node (e.g. source gNB) and/or the target network node (e.g. target gNB) in response to the source network node (e.g. source gNB) and/or the target network node (e.g. target gNB) receiving a UE capability. The source network node (e.g. source gNB) and/or the target network node (e.g. target gNB) transfer function may depend on a source network node (e.g. source gNB) and/or a target network node (e.g. target gNB) capability.

The source network node (e.g. source gNB) and/or the target network node (e.g. target gNB) capability may comprise static components, semi-static components (e.g. features implemented in a gNB that are standardized and/or product specific such as support of different UL and DL features, cell configuration, hardware processing ability and/or software processing ability) and/or dynamic components (e.g. features implemented in a gNB that are variable such as a number of component carriers, a number of antenna configurations, a transmission power, an internet protocol (IP) and/or virtual local area network (VLAN) connectivity, a power saving level, a load level and congestion level). The source network node (e.g. source gNB) and/or the target network node (e.g. target gNB) capability may be a function of time.

The parameters of FIG. 5 may be defined as follows:

Xᵢ may be a UE capability vector of user i. The UE capability vector may typically comprise 9000 octets.

H(t) may be the source network node (e.g. source gNB) and/or the target network node (e.g. target gNB) transfer function. The source network node (e.g. source gNB) and/or the target network node (e.g. target gNB) transfer function may be time dependent.

Yi(t) may be a UE configuration vector of user i. The UE configuration vector may be time dependent. The UE configuration vector may be conveyed within an RRC message. An RRC message may comprise a maximum of 45000 octets assuming segmentation. RRC message sizes comprise typically between 3000 and 5000 octets including the UE configuration vector.

Potentially given the large UE population and diverse use cases and/or diverse network deployments, the amount of possible UE configurations could potentially run into millions of combinations. For example, a conservative estimate yields already a million combinations for 1000 worldwide UE capabilities (UE models)*100 network deployments (arrangement of network nodes, number of component carriers, antenna configurations, transmission power, IP and/or VLAN connectivity, power saving algorithms, load and congestion control states)*10 service types (e.g. subscription types).

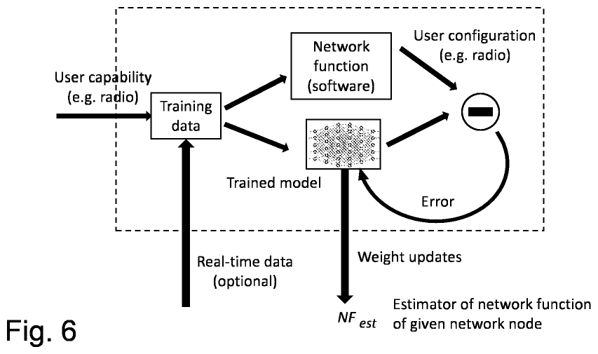

FIG. 6 shows a schematic representation of a method for providing, to a source network node (e.g. source gNB), a model NFₑₛₜ of a target network node transfer function.

A model NFₑₛₜ of the target network transfer function may be generated by determining correlations and/or patterns between the UE configuration generated by the target network node (e.g. target gNB) and the UE capability received by the target network node (e.g. target gNB).

Alternatively, a model NFₑₛₜ of the target network transfer function may be generated by determining correlations and/or patterns between the UE configuration generated by the target network node (e.g. target gNB) and the UE capability received by the target network node (e.g. target gNB) for various combinations of real-time data. The real-time data may comprise target network node capability.

The model NFₑₛₜ may be an artificial intelligence and/or machine learning model. The model may be in a format that can be shared with the neighbouring network nodes (e.g. gNBs) including the source network node (e.g. source gNB), such that exposure of the model through network interfaces may be avoided. In one option, this can be done by sending the model in a transparent container through the network interfaces.

In a training phase, the target network node (e.g. target gNB) may receive a UE capability and a UE configuration may be generated by the target network node (e.g. target gNB). Likewise, the model NFₑₛₜ of the target network transfer function may receive the UE capability and an estimation of a UE configuration may be generated by the target network node (e.g. target gNB). An error may be computed by comparing the UE configuration generated by the target network node (e.g. target gNB) and the estimation of the UE configuration generated by the model NFₑₛₜ of the target network transfer function. The error may be used to update the model NFₑₛₜ of the target network transfer function. For example, the error may be used to update weights of the model NFₑₛₜ of the target network transfer function. The training phase may be performed periodically or aperiodically until the error converges.

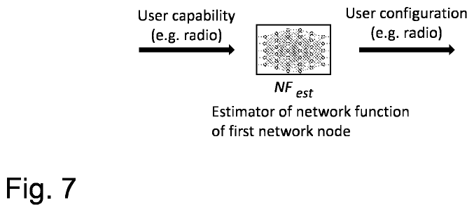

FIG. 7 shows a schematic representation of a method for using, by a source network node (e.g. source gNB), a model NFₑₛₜ of a target network node transfer function. The method may involve UE-associated signaling and may be performed before a handover procedure.

The model NFₑₛₜ of the target network node transfer function may be used by the source network node (e.g. source gNB) to predict the UE configuration that would be generated by the target network node (e.g. target gNB) that the UE would be handed over from the source network node (e.g. source gNB) to the target network node (e.g. target gNB). The source network node (e.g. source gNB) may predict what performance the network and/or the UE may expect in the event that the UE would be handed over from the source network node (e.g. source gNB) to the target network node (e.g. target gNB).

In this way, the source network node (e.g. source gNB) can make an informed decision as to whether the UE should be handed over from the source network node (e.g. source gNB) to the target network node (e.g. target gNB). The source network node (e.g. source gNB), in this way, may deal with situations where failure or poor performance are frequent, such as handover, in a smarter manner.

Another method for using, by a source network node (e.g. source gNB), a model NFₑₛₜ of a target network node transfer function may be provided. The method may involve non-UE-associated signaling and may be performed before a handover procedure.

The model NFₑₛₜ of the target network node transfer function may be used by the source network node (e.g. source gNB) to predict the UE configuration that would be generated by the target network node (e.g. target gNB) in the event that a group of UEs would be handed over from the source network node (e.g. source gNB) to the target network node (e.g. target gNB). The source network node (e.g. source gNB) may predict what performance the network and/or the group of UEs may expect in the event that the group of UEs would be handed over from the source network node (e.g. source gNB) to the target network node (e.g. target gNB). The group of UEs may be defined in terms of a slice (e.g., enhanced mobile broadband, extended reality), in terms of a user category or other.

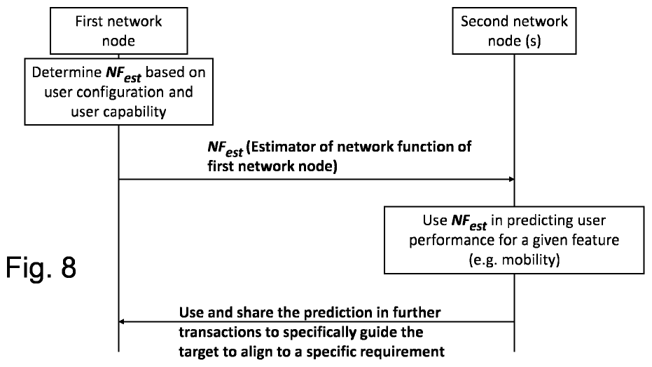

FIG. 8 shows a signaling diagram of a process combining a method for providing a model NFₑₛₜ of a target network node transfer function and a method for using the model NFₑₛₜ of the target network node transfer function.

A first network node, for example a target network node (e.g. target gNB) may determine a model NFₑₛₜ of a first network node transfer function. The model NFₑₛₜ of the first network node transfer function may be based on UE configuration generated by the first network node and UE capability received by the first network node) as discussed in reference to FIG. 6.

The first network node may provide the model NFₑₛₜ of the first network node transfer function to one or more second network nodes, here including a source network node (e.g. source gNB).

The one or more second network nodes may use the model NFₑₛₜ of the first network node transfer function to predict what performance the network and/or the UE may expect in the event that a feature is implemented, for example the event that the UE would be handed over from the source network node (e.g. source gNB) to the target network node (e.g. target gNB).

The one or more second network nodes may use the model NFₑₛₜ of the first network node transfer function to determine whether the feature should actually be implemented, for example whether the UE should be handed over from the source network node (e.g. source gNB) to the target network node (e.g. target gNB).

The one or more second network nodes may share the prediction with the first network node. The first network node may use the prediction to align to a specific requirement. A specific requirement may comprise the success of a handover procedure. The success of the handover procedure may include the success of admitting all the packet data unit sessions of the UE at the target network node. Another specific requirement may comprise the success of a random access procedure. Another specific requirement may comprise an average throughput offered to a given service under traffic offloading (e.g. to a small cell). Another specific requirement may comprise an latency offered to a given service. Another specific requirement may comprise meeting a configured survival time.

FIGS. 9a and 9b show a signaling diagram of a process for providing a prediction or a model of a target network node transfer function to compute a prediction.

It may be assumed that a source network node (e.g. source gNB) may not have a model NFₑₛₜ of a target network node (e.g. target gNB). Despite not being able to predict what performance the network and/or the UE may expect in the event that the UE would be handed over from the source network node (e.g. source gNB) to the target network node (e.g. target gNB), the source network node (e.g. source gNB) would like to handover the UE from the source network node (e.g. source gNB) to the target network node (e.g. target gNB).

However, the source network node (e.g. source gNB) would like to receive the model NFₑₛₜ of the target network node (e.g. target gNB) for future use.

This scenario may be applicable during a training phase or retraining phase when the model NFₑₛₜ of the target network node (e.g. target gNB) is not accurate enough (e.g. the error has not converged yet) and the target network node (e.g. target gNB) has not yet provided the model NFₑₛₜ of the target network node (e.g. target gNB) to neighbouring network nodes (e.g. gNBs) including the source network node (e.g. source gNB).

It may be assumed that the source network node (e.g. source gNB) may serve a plurality of UEs. To increase the intelligibility of the description only one UE will be discussed. However, it will be understood that the steps may be repeated for some or all of the plurality of UEs.

In step 1 the source network node (e.g. source gNB) may send a request to a UE to receive UE capability.

In step 2 the source network node (e.g. source gNB) may receive UE capability from the UE.

In step 3 the source network node (e.g. source gNB) may store the UE capability.

In step 4 the source network node (e.g. source gNB) may receive a measurement report from the UE.

In step 5 the source network node (e.g. source gNB) may decide to hand over the UE from the source network node (e.g. source gNB) to the target network node (e.g. target gNB). The source network node (e.g. source gNB) may decide to hand over the UE from the source network node (e.g. source gNB) to the target network node (e.g. target gNB) for radio purpose, load balancing purpose, traffic steering purpose or other.

In step 6 the source network node (e.g. source gNB) may send a handover request to the target network node (e.g. target gNB). The handover request may comprise an identifier of the UE, a UE configuration generated by the source network node (e.g. source gNB), the UE capability and/or a request to receive a model NFₑₛₜ of the target network node (e.g. target gNB) for future use.

The handover request may comprise a desired level confidence, accuracy or reliability for the model NFₑₛₜ of the target network node (e.g. target gNB).

The handover request may comprise a criterion defining when the target network node (e.g. target gNB) should provide an up-to-date model NFₑₛₜ of the target network node (e.g. target gNB). The criterion may be a periodicity (e.g. every X seconds where X is an integer). The criterion may be an event (e.g. a condition occurring at the network node (e.g. target gNB) (e.g. load exceeding a threshold or power savings mode being ON). The criterion may be a time when an event is predicted to occur (e.g. a time when a load is predicted to exceed a threshold if the target network node (e.g. target gNB) runs an artificial intelligence or machine learning algorithm running that calculates load predictions).

Alternatively, the handover request may not comprise the request to provide a model NFₑₛₜ of the target network node (e.g. target gNB) for future use. The source network node (e.g. source gNB) may not use the model NFₑₛₜ of the target network node (e.g. target gNB) to predict what performance the network and/or the UE may expect in the event that the UE would be handed over from the source network node (e.g. source gNB) to the target network node (e.g. target gNB).

Instead, the target network node (e.g. target gNB) may use the model NFₑₛₜ of the target network node (e.g. target gNB) to predict what performance the network and/or the UE may expect in the event that the UE would be handed over from the source network node (e.g. source gNB) to the target network node (e.g. target gNB). The handover request may comprise a request to provide a prediction of what performance the network and/or the UE may expect in the event that the UE would be handed over from the source network node (e.g. source gNB) to the target network node (e.g. target gNB).

In step 7, the target network node (e.g. target gNB) may perform load and admission control.

In step 8, the target network node (e.g. target gNB) may generate UE configuration that could be used by the UE in the event that the UE is handed over from the source network node (e.g. source gNB) to the target network node (e.g. target gNB). The UE configuration that could be used by the UE in the event that the UE is handed over from the source network node (e.g. source gNB) to the target network node (e.g. target gNB) may be generated based on UE capability and/or target network node capability.

In step 9, the target network node (e.g. target gNB) may send a request to a training host to update the model NFₑₛₜ of the target network node (e.g. target gNB). The request may comprise a procedure type indicator indicating that a network procedure request is a handover, the UE configuration generated by the target network node (e.g. target gNB) mapped to the UE capability received by the target network node (e.g. target gNB) and/or the target network node capability.

The training host may be a deep neural network agent when a neural network is used to compute the model NFₑₛₜ of the target network node (e.g. target gNB). The training host may be a part of the target network node (e.g. target gNB) or separate from the target network node (e.g. target gNB).

The training host may be configured to provide the model NFₑₛₜ of the target network node (e.g. target gNB) to the neighboring network nodes (e.g. gNBs) within a geographical scope (e.g. cell, tracking area or a zone within a public land mobile network). This could be based on the neighbour relationships configured/learnt from other methods, from the OAM entity or from an open RAN intelligent controller in case of open RAN architecture. Neighbour relations may be established by ancillary methods (e.g. reporting procedures using self-organizing network or minimization of drive testing to establish and determine neighbour relationships which network node would need to be connected to another network node using the X2/Xn interfaces.

In step 10, the target network node (e.g. target gNB) may receive an up-to-date model NFₑₛₜ of the target network node (e.g. target gNB). The target network node (e.g. target gNB) may receive up-to-date weights of the model NFₑₛₜ of the target network node (e.g. target gNB).

In step 11, the target network node (e.g. target gNB) may store the model NFₑₛₜ of the target network node (e.g. target gNB).

In step 12, the target network node (e.g. target gNB) may send a handover request acknowledgement to the source network node (e.g. source gNB).

The handover request acknowledgement may comprise the UE configuration generated by the target network node (e.g. target gNB) that could be used by the UE in the event that the UE is handed over from the source network node (e.g. source gNB) to the target network node (e.g. target gNB). The UE configuration may be provided within a handover container.

The handover request acknowledgement may comprise the model NFₑₛₜ of the target network node (e.g. target gNB). The model may be provided within a separate container. The separate container may be defined as an OCTET STRING in ASN.1. The separate container may carry model parameters (e.g. model weights).

The handover request acknowledgement may comprise metadata to allow the source network node (e.g. source gNB) to understand how to interpret the model NFₑₛₜ of the target network node (e.g. target gNB). The metadata may indicate that the model NFₑₛₜ of the target network node (e.g. target gNB) applies to a handover procedure as opposed to other network procedures also involving the source network node (e.g. source gNB and the target network node (e.g. target gNB) and also potentially impacting UE experience.

It will be understood that network procedures involving the source network node (e.g. source gNB and the target network node (e.g. target gNB) may comprise a handover procedure (e.g. baseline handover procedure or conditional handover procedure, dual active protocol stack handover procedure from source network node to a target node) or dual connectivity procedure (e.g. handover of a primary cell, change of primary secondary cell, dual connectivity SgNB addition procedure, NR-NR dual connectivity or LTE-NR dual connectivity).

In dual connectivity, a handover procedure may refer to a handover of a primary cell from e.g. source master network node 1 to target master network node 2 and change of primary secondary cell may refer to change from source secondary network node 1 to target secondary network node 2.

A dual connectivity SgNB addition procedure may refer to the addition of a secondary network node to a master network node to form dual connectivity.

The metadata may allow the source network node (e.g. source gNB) to use the model. The metadata may indicate a level of confidence, accuracy or reliability (e.g. in the form of a percentage). The metadata may indicate a period of time for which the model will remain valid (e.g. a coherence time which tells how quickly the model NFₑₛₜ of the target network node (e.g. target gNB) becomes stale. The coherence time may be indicated in a period of time (e.g. hundreds of milliseconds) or as an autocorrelation function which may be used by the source network node (e.g. source gNB) to determine staleness of the model NFₑₛₜ of the target network node (e.g. target gNB). The metadata may indicate that the model NFₑₛₜ of the target network node (e.g. target gNB) is valid to predict for some or all UE configurations. For example, the model NFₑₛₜ of the target network node (e.g. target gNB) is only valid to predict a carrier aggregation UE configuration, a multiple input multiple output UE configuration, a beamforming UE configuration, a bandwidth part UE configuration, a channel bandwidth UE configuration, a subcarrier UE configuration or other UE configuration.

The handover request acknowledgement may comprise an indication that a coherence time of the model NFₑₛₜ of the target network node (e.g. target gNB) has not expired or that the model NFₑₛₜ of the target network node (e.g. target gNB) has not been (significantly) updated since a previous time the model NFₑₛₜ of the target network node (e.g. target gNB) was updated by the training host.

The coherence time of the NFₑₛₜ of the target network node (e.g. target gNB) may refer to the time period in which the model NFₑₛₜ of the target network node (e.g. target gNB) is considered to provide reliable predictions. Outside the coherence time the predictions of the model NFₑₛₜ of the target network node (e.g. target gNB) are no longer considered valid and an up-to-date model NFₑₛₜ of the target network node (e.g. target gNB) may be required.

These may happen mainly due to two reasons: one reason is that there are new UEs admitted into the system whose capabilities are different compared to the ones that are already learnt leading to model update required or just that the target nodes operating condition (e.g. load or power saving status) impacts the model. In both cases it is easy to see that the model is basically stale and needs to be updated to allow the sense of “time” to be incorporated into this. Hence the model transfer function is defined as h (t) which implies this is a function of time.

Alternatively, the handover request acknowledgement may not comprise the model NFₑₛₜ of the target network node (e.g. target gNB). The handover request acknowledgement may comprise a prediction indicator (i.e. inference indicator) indicating what performance the network and/or the UE may expect in the event that the UE would be handed over from the source network node (e.g. source gNB) to the target network node (e.g. target gNB). The prediction indicator can be meant as a prediction indicator of network node performance. The prediction indicator may indicate a chance of success in the event that the UE would be handed over from the source network node (e.g. source gNB) to the target network node (e.g. target gNB). The prediction indicator may comprise one or more value in the interval [0,1] for one or more key performance indicators (load and admission control, random access channel procedure or the like). The prediction indicator may comprise a joint value in the interval [0,1] for one or more key performance indicators (load and admission control, random access channel procedure or the like). The prediction indicator may comprise a binary value that indicates success or failure. The prediction indicator may comprise a soft value (a range of possible performances e.g., good, average, medium, bad or of a finer granularity). The soft value may be coupled by a time which may further indicate until when the prediction indicator will be valid (viewed by the source network node (e.g. source gNB) as a coherence time or a wait time).

The prediction indicator may be for a single UE or for a group of UEs. The grouping may be based on UE capability, UE types, cells served by the target network node (e.g. target gNB) or the like.

In step 13, the source network node (e.g. source gNB) may store the model NFₑₛₜ Of the target network node (e.g. target gNB).

In step 14, the source network node (e.g. source gNB) may send a RRCReconfiguration message to the UE. The RRCReconfiguration message may comprise the UE configuration generated by the target network node (e.g. target gNB) that could be used by the UE in the event that the UE is handed over from the source network node (e.g. source gNB) to the target network node (e.g. target gNB). The UE configuration may be provided within a handover container.

In step 15, the UE may switch from a cell served by the source network node (e.g. source gNB) to a cell served by the target network node (e.g. target gNB) based on the UE configuration.

In step 16, it may happen that the model NFₑₛₜ of the target network node (e.g. target gNB) is updated by the training host and stored at the target network node (e.g. target gNB) due to a handover request message sent by another source network node (e.g. source gNB) and the target network node (e.g. target gNB), due to a change of target network node capability (e.g. change of load level, change of power saving level, prediction of power saving level or other at the target network node (e.g. target gNB)).

In such scenario, the target network node (e.g. target gNB) may trigger the training host to generate an up-to-date model NFₑₛₜ of the target network node (e.g. target gNB). The trigger may be periodical or event based. The trigger may be negotiated with the training host or with the 5GC (e.g. operations administration and maintenance). The target network node (e.g. target gNB) may provide the up-to-date model NFₑₛₜ of the target network node (e.g. target gNB) to the source network node (e.g. source gNB). That is, the up-to-date model NFₑₛₜ of the target network node (e.g. target gNB) may be pushed to the source network node (e.g. source gNB) rather than pulled by the source network node (e.g. source gNB). However, it may be understood that the up-to-date model NFₑₛₜ of the target network node (e.g. target gNB) may be pulled by the source network node (e.g. source gNB).

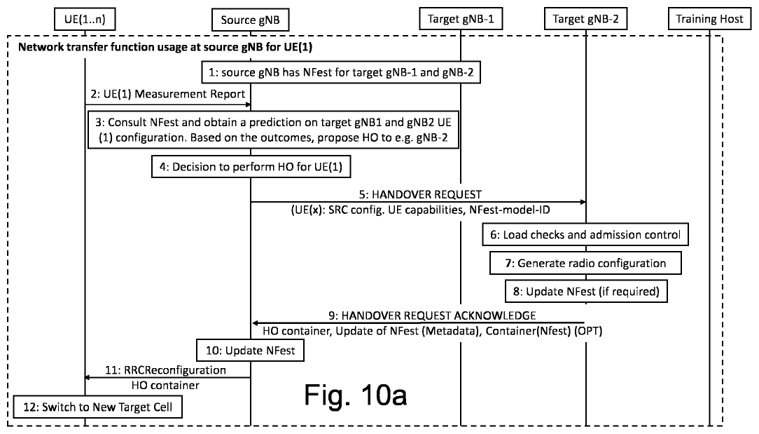

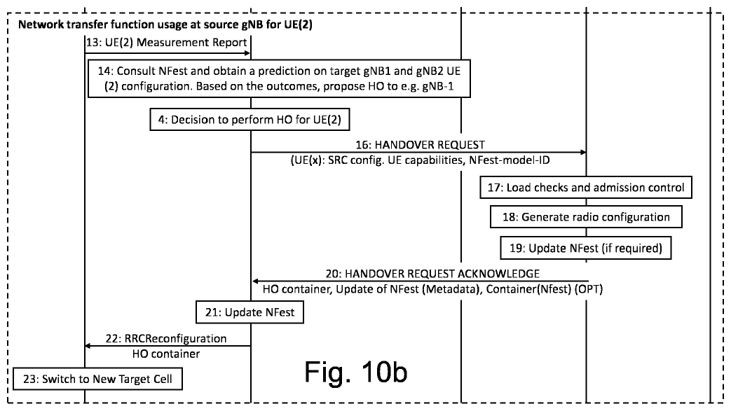

FIGS. 10a and 10b show a signaling diagram of a process for using a prediction or a model NFₑₛₜ of a target network node transfer function to compute a prediction.

It may be assumed that a source network node (e.g. source gNB) may serve a plurality of UEs. To increase the intelligibility of the description only one UE will be discussed. However, it will be understood that the steps may be repeated for some or all of the plurality of UEs.

In step 1, the source network node (e.g. source gNB) has been provided a model NFₑₛₜ of a first target network node (e.g. target gNB-1) and a model NFₑₛₜ of a second target network node (e.g. target gNB-2). The source network node (e.g. source gNB) may store the model NFₑₛₜ of the first target network node (e.g. target gNB-1) and the model NFₑₛₜ of the second target network node (e.g. target gNB-2) for future use.

In step 2, the source network node (e.g. source gNB) may receive a measurement report from a UE.

In step 3, the source network node (e.g. source gNB) may determine that the first target network node (e.g. target gNB-1) and the second target network node (e.g. target gNB-2) are candidates to hand over the UE from the source network node (e.g. source gNB).

The source network node (e.g. source gNB) may use the model NFₑₛₜ of the first target network node (e.g. target gNB-1) to predict the UE configuration that could be used by the UE in the event that the UE would be handed over from the source network node (e.g. source gNB) to the first target network node (e.g. target gNB-1).

Likewise, the source network node (e.g. source gNB) may use the model NFₑₛₜ of the second target network node (e.g. target gNB-2) to predict the UE configuration that could be used by the UE in the event that the UE would be handed over from the source network node (e.g. source gNB) to the second target network node (e.g. target gNB-2).

The source network node (e.g. source gNB) may compare the UE configuration that could be used by the UE in the event that the UE would be handed over from the source network node (e.g. source gNB) to the first target network node (e.g. target gNB-1) and the UE configuration that could be used by the UE in the event that the UE would be handed over from the source network node (e.g. source gNB) to the second target network node (e.g. target gNB-2).

The source network node (e.g. source gNB) may determine that the UE experience would be less impacted in the event that the UE would be handed over from the source network node (e.g. source gNB) to the second target network node (e.g. target gNB-2) than in the event that the UE would be handed over from the source network node (e.g. source gNB) to the first target network node (e.g. target gNB-1) based on the comparing. For example, the second target network node (e.g. target gNB-2) would admit all packet data unit (PDU) sessions whereas the first target network node (e.g. target gNB-1) would drop one PDU session).

In step 4, the source network node (e.g. source gNB) may determine that the UE is to be handed over from the source network node (e.g. source gNB) to the second target network node (e.g. target gNB-2).

In step 5, the source network node (e.g. source gNB) may send a handover request to the second target network node (e.g. target gNB-2). The handover request may comprise an identifier of the UE, a UE configuration generated by the source network node (e.g. source gNB), the UE capability, an identifier of the model NFₑₛₜ of the second target network node (e.g. target gNB-2) used to predict the UE configuration that could be used by the UE in the event that the UE would be handed over from the source network node (e.g. source gNB) to the second target network node (e.g. target gNB-2) and/or an identifier characterizing how the second target network node (e.g. target gNB-2) was selected. The identifier characterizing how the second target network node (e.g. target gNB-2) was selected may comprise an identifier of a prediction indicator received from the second target network node (e.g. target gNB-2) as discussed in reference to FIG. 9.

In step 6, the second target network node (e.g. target gNB-2) may perform load and admission control.

In step 7, the second target network node (e.g. target gNB-2) may generate UE configuration that could be used by the UE in the event that the UE is handed over from the source network node (e.g. source gNB) to the second target network node (e.g. target gNB-2). The UE configuration that could be used by the UE in the event that the UE is handed over from the source network node (e.g. source gNB) to the second target network node (e.g. target gNB-2) may be generated based on the UE capability and/or the second target network node capability.

In step 8, the second target network node (e.g. target gNB-2) may send a request to a training host to update the model NFₑₛₜ of the second target network node (e.g. target gNB-2). The request may comprise a procedure type indicator indicating that a network procedure request is a handover, the UE configuration generated by the second target network node (e.g. target gNB-2) mapped to the UE capability received by the second target network node (e.g. target gNB-2) and/or the second target network node capability.

The second target network node (e.g. target gNB-2) may receive an up-to-date model NFₑₛₜ of the second target network node (e.g. target gNB-2). The second target network node (e.g. target gNB-2) may receive up-to-date weights of the model NFₑₛₜ of the second target network node (e.g. target gNB-2).

The second target network node (e.g. target gNB-2) may store the model NFₑₛₜ of the second target network node (e.g. target gNB-2).

In step 9, the second target network node (e.g. target gNB-2) may send a handover request acknowledgement to the source network node (e.g. source gNB).

The handover request acknowledgement may comprise the UE configuration generated by the second target network node (e.g. target gNB-2) that could be used by the UE in the event that the UE is handed over from the source network node (e.g. source gNB) to the second target network node (e.g. target gNB-2). The UE configuration may be provided within a handover container

The handover request acknowledgement may comprise the model NFₑₛₜ of the second target network node (e.g. target gNB-2). The model may be provided within a separate container. The separate container may be defined as an OCTET STRING in ASN.1. The separate container may carry model parameters (e.g. model weights).

The handover request acknowledgement may comprise metadata to allow the source network node (e.g. source gNB) to understand how to interpret the model NFₑₛₜ of the second target network node (e.g. target gNB-2). The metadata may indicate that the model NFₑₛₜ of the second target network node (e.g. target gNB-2) applies to a handover procedure as opposed to other network procedures also involving the source network node (e.g. source gNB and the second target network node (e.g. target gNB-2) and also potentially impacting UE experience.

It will be understood that network procedures involving the source network node (e.g. source gNB and the second target network node (e.g. target gNB-2) may comprise handover procedures (e.g. baseline handover procedure or conditional handover procedure), dual connectivity procedure (e.g. dual active protocol stack procedure).

The metadata may allow the source network node (e.g. source gNB) to use the model. The metadata may indicate a level of confidence, accuracy or reliability (e.g. in the form of a percentage). The metadata may indicate that the model NFₑₛₜ of the second target network node (e.g. target gNB-2) is valid to predict for some or all UE configuration. For example, the model NFₑₛₜ of the second target network node (e.g. target gNB-2) is only valid to predict a carrier aggregation UE configuration, a multiple input multiple output UE configuration, a beamforming UE configuration, a bandwidth part UE configuration, a channel bandwidth UE configuration, a subcarrier UE configuration or other UE configuration.

The handover request acknowledgement may comprise an indication that a coherence time of the model NFₑₛₜ of the target network node (e.g. target gNB) has not expired or that the model NFₑₛₜ of the second target network node (e.g. target gNB-2) has not been (significantly) updated since a previous time the model NFₑₛₜ of the second target network node (e.g. target gNB-2) was updated by the training host.

Alternatively, the handover request acknowledgement may not comprise the model NFₑₛₜ of the target network node (e.g. target gNB). The handover request acknowledgement may comprise a prediction indicator (i.e. inference indicator) indicating what performance the network and/or the UE may expect in the event that the UE would be handed over from the source network node (e.g. source gNB) to the target network node (e.g. target gNB). The prediction indicator may indicate a chance of success in the event that the UE would be handed over from the source network node (e.g. source gNB) to the target network node (e.g. target gNB). The prediction indicator may comprise one or more value in the interval [0,1] for one or more key performance indicators (load and admission control, random access channel procedure or the like). The prediction indicator may comprise a joint value in the interval [0,1] for one or more key performance indicators (load and admission control, random access channel procedure or the like). The prediction indicator may comprise a binary value that indicate success or failure. The prediction indicator may comprise a soft value (a range of possible performances e.g., good, average, medium, bad or of a finer granularity). The soft value may be coupled by a time which may further indicate until when prediction indicator will be valid (viewed by the source network node (e.g. source gNB) as a coherence time or a wait time). Providing this prediction indicator from the target network node (e.g. target gNB) to the source network node (e.g. source gNB) may help the source network node (e.g. source gNB) to evaluate its own actions, and in a sense retrain/educate/improve, by comparing the outcome of an attempted handover to a target network node (e.g. target gNB) to the prediction indicator.

In step 10, the source network node (e.g. source gNB) may store the model NFₑₛₜ of the second target network node (e.g. target gNB-2).

The up-to-date model NFₑₛₜ of the second target network node (e.g. target gNB-2) stored at the source network node (e.g. source gNB) may allow a better prediction of key performance indicators (e.g. probability of early/late handover, mobility failure due to random access failure or the like). This may be enabled by the metadata indicating a level of confidence, accuracy or reliability (e.g. in the form of a percentage) for these key performance indicators.

The up-to-date model NFₑₛₜ of the second target network node (e.g. target gNB-2) stored at the source network node (e.g. source gNB) may also allow a more optimal selection of UE configuration that would be used by the UE in the event that the UE is handed over form the source network node (e.g. source gNB) to the second target network node (e.g. target gNB-2). For example, the up-to-date model NFₑₛₜ of the second target network node (e.g. target gNB-2) stored at the source network node (e.g. source gNB) may allow improved selection of target cells in a gNB (i.e. carrier aggregation), selection of optimal band combination, channel bandwidth/sub-carrier spacing, location of the bandwidth part or the like.

In step 11, the source network node (e.g. source gNB) may send a RRCReconfiguration message to the UE. The RRCReconfiguration message may comprise the UE configuration generated by the second target network node (e.g. target gNB-2) that could be used by the UE in the event that the UE is handed over from the source network node (e.g. source gNB) to the second target network node (e.g. target gNB-2). The UE configuration may be provided within a handover container.

In step 12, the UE may switch from a cell served by the source network node (e.g. source gNB) to a cell served by the second target network node (e.g. target gNB-2) based on the UE configuration.

It will be understood that a similar sequence of steps may be performed for another UE.

In step 13, the source network node (e.g. source gNB) may receive a measurement report from the other UE.

In step 14, the source network node (e.g. source gNB) may determine that the first target network node (e.g. target gNB-1) and the second target network node (e.g. target gNB-2) are candidates to hand over the other UE from the source network node (e.g. source gNB).

The source network node (e.g. source gNB) may use the model NFₑₛₜ of the first target network node (e.g. target gNB-1) to predict the UE configuration that could be used by the other UE in the event that the other UE would be handed over from the source network node (e.g. source gNB) to the first target network node (e.g. target gNB-1).

Likewise, the source network node (e.g. source gNB) may use the model NFₑₛₜ of the second target network node (e.g. target gNB-2) to predict the UE configuration that could be used by the other UE in the event that the other UE would be handed over from the source network node (e.g. source gNB) to the second target network node (e.g. target gNB-2).

The source network node (e.g. source gNB) may compare the UE configuration that could be used by the other UE in the event that the UE would be handed over from the source network node (e.g. source gNB) to the first target network node (e.g. target gNB-1) and the UE configuration that could be used by the other UE in the event that the UE would be handed over from the source network node (e.g. source gNB) to the second target network node (e.g. target gNB-2).

The source network node (e.g. source gNB) may determine that the UE experience would be less impacted in the event that the other UE would be handed over from the source network node (e.g. source gNB) to the first target network node (e.g. target gNB-1) than in the event that the UE would be handed over from the source network node (e.g. source gNB) to the second target network node (e.g. target gNB-2) based on the comparing. For example, the first target network node (e.g. target gNB-1) would admit all packet data unit (PDU) sessions whereas the second target network node (e.g. target gNB-2) would drop one PDU session).

In step 15, the source network node (e.g. source gNB) may determine that the other UE is to be handed over from the source network node (e.g. source gNB) to the first target network node (e.g. target gNB-1).

In step 16, the source network node (e.g. source gNB) may send a handover request to the first target network node (e.g. target gNB-1). The handover request may comprise an identifier of the other UE, a UE configuration generated by the source network node (e.g. source gNB), the UE capability and/or an identifier of the model NFₑₛₜ of the first target network node (e.g. target gNB-1) used to predict the UE configuration that could be used by the other UE in the event that the other UE would be handed over from the source network node (e.g. source gNB) to the first target network node (e.g. target gNB-1).

In step 17, the first target network node (e.g. target gNB-1) may perform load and admission control.

In step 18, the first target network node (e.g. target gNB-1) may generate UE configuration that could be used by the other UE in the event that the UE is handed over from the source network node (e.g. source gNB) to the first target network node (e.g. target gNB-1). The UE configuration that could be used by the other UE in the event that the other UE is handed over from the source network node (e.g. source gNB) to the first target network node (e.g. target gNB-1) may be generated based on the UE capability and/or the first target network node capability.

In step 19, the first target network node (e.g. target gNB-1) may send a request to a training host to update the model NFₑₛₜ of the first target network node (e.g. target gNB-2). The request may comprise a procedure type indicator indicating that a network procedure request is a handover, the UE configuration generated by the first target network node (e.g. target gNB-1) mapped to the UE capability received by the first target network node (e.g. target gNB-1) and/or the first target network node capability.

The first target network node (e.g. target gNB-1) may receive an up-to-date model NFₑₛₜ of the first target network node (e.g. target gNB-1). The first target network node (e.g. target gNB-1) may receive up-to-date weights of the model NFₑₛₜ of the first target network node (e.g. target gNB-1).

The first target network node (e.g. target gNB-1) may store the model NFₑₛₜ of the first target network node (e.g. target gNB-1).

In step 20, the first target network node (e.g. target gNB-1) may send a handover request acknowledgement to the source network node (e.g. source gNB).

The handover request acknowledgement may comprise the UE configuration generated by the first target network node (e.g. target gNB-1) that could be used by the other UE in the event that the other UE is handed over from the source network node (e.g. source gNB) to the first target network node (e.g. target gNB-1). The UE configuration may be provided within a handover container

The handover request acknowledgement may comprise the model NFₑₛₜ of the first target network node (e.g. target gNB-1). The model may be provided within a separate container. The separate container may be defined as an OCTET STRING in ASN.1. The separate container may carry model parameters (e.g. model weights).

The handover request acknowledgement may comprise metadata to allow the source network node (e.g. source gNB) to understand how to interpret the model NFₑₛₜ of the first target network node (e.g. target gNB-1). The metadata may indicate that the model NFₑₛₜ of the first target network node (e.g. target gNB-1) applies to a handover procedure as opposed to other network procedures also involving the source network node (e.g. source gNB and the first target network node (e.g. target gNB-1) and also potentially impacting UE experience.

It will be understood that network procedures involving the source network node (e.g. source gNB and the first target network node (e.g. target gNB-1) may comprise handover procedures (e.g. baseline handover procedure or conditional handover procedure), dual connectivity procedure (e.g. dual active protocol stack procedure).

The metadata may allow the source network node (e.g. source gNB) to use the model. The metadata may indicate a level of confidence, accuracy or reliability (e.g. in the form of a percentage). The metadata may indicate that the model NFₑₛₜ of the first target network node (e.g. target gNB-1) is valid to predict for some or all UE configuration. For example, the model NFₑₛₜ of the first target network node (e.g. target gNB-1) is only valid to predict a carrier aggregation UE configuration, a multiple input multiple output UE configuration, a beamforming UE configuration, a bandwidth part UE configuration, a channel bandwidth UE configuration, a subcarrier UE configuration or other UE configuration.

The handover request acknowledgement may comprise an indication that a coherence time of the model NFₑₛₜ of the target network node (e.g. target gNB) has not expired or that the model NFₑₛₜ of the first target network node (e.g. target gNB-1) has not been (significantly) updated since a previous time the model NFₑₛₜ of the first target network node (e.g. target gNB-2) was updated by the training host.

It will be understood that the model NFₑₛₜ of the first target network node (e.g. target gNB-1) is not necessarily conveyed within the handover request acknowledgement. The model NFₑₛₜ of the first target network node (e.g. target gNB-1) may be conveyed within non-UE associated signaling such as NG-RAN node configuration update acknowledge message (see TS 38.423) as a response to NG-RAN node configuration update message that is sent from the source network node (e.g. source gNB) and carrying the request to receive the model NFₑₛₜ of the first target network node (e.g. target gNB-1) for future use.

In step 21, the source network node (e.g. source gNB) may store the model NFₑₛₜ Of the first target network node (e.g. target gNB-2).

The up-to-date model NFₑₛₜ of the first target network node (e.g. target gNB-1) stored at the source network node (e.g. source gNB) may allow a better prediction of key performance indicators (e.g. probability of early/late handover, mobility failure due to random access failure or the like). This may be enabled by the metadata indicating a level of confidence, accuracy or reliability (e.g. in the form of a percentage) for these key performance indicators.

The up-to-date model NFₑₛₜ of the first target network node (e.g. target gNB-1) stored at the source network node (e.g. source gNB) may also allow a more optimal selection of UE configuration that would be used by the UE in the event that the UE is handed over form the source network node (e.g. source gNB) to the first target network node (e.g. target gNB-1). For example, the up-to-date model NFₑₛₜ of the first target network node (e.g. target gNB-1) stored at the source network node (e.g. source gNB) may allow improved selection of target cells in a gNB (i.e. carrier aggregation), selection of optimal band combination, channel bandwidth/sub-carrier spacing, location of the bandwidth part or the like.

In step 22, the source network node (e.g. source gNB) may send a RRCReconfiguration message to the UE. The RRCReconfiguration message may comprise the UE configuration generated by the first target network node (e.g. target gNB-1) that could be used by the UE in the event that the UE is handed over from the source network node (e.g. source gNB) to the first target network node (e.g. target gNB-1). The UE configuration may be provided within a handover container.

In step 23, the UE may switch from a cell served by the source network node (e.g. source gNB) to a cell served by the first target network node (e.g. target gNB-1) based on the UE configuration.

It will be understood that, although the above examples have been described in the context of a handover procedure involving a source network node (e.g. source gNB) to a target network node (e,g. target gNB), other examples may be contemplated in the context of other network procedures involving a source network node (e.g. source gNB) to a target network node (e,g. target gNB). In particular, examples may be contemplated in the context of a dual connectivity addition of a secondary network node (e.g. SgNB) procedure, a baseline handover procedure, a conditional handover procedure, a dual active protocol stack handover procedure.

It will be understood that when a source network node (e.g. source gNB) consults the model NFₑₛₜ of the transfer function of a target network node (e.g. target gNB), the source network node (e.g. source gNB) may estimate the impact on the network and/or the UE performance using one or more metrics. These metrics may comprise a throughput metric, a delay/latency metric, a power-saving metric, a mobility performance metric, a deadline driven metric (e.g. survival time) or the like. Joint network and/or UE performance may be estimated by the source network node (e.g. source gNB) by taking a weighted sum of some or all of these metrics to give an overall “score” for a given target network node, a given procedure and/or a given UE.

One or more aspects of this disclosure provide one or more of the following advantages.

From a system level perspective, a source network node (e.g source gNB) can use the learnt model of a target network node (e.g. target gNB) and make a prediction of what kind of performance a network and/or UE can enjoy if handover is implemented with the target network node (e.g. target gNB). It may be helpful and/or critical to ensure for example that the radio performance is deterministic for some specific use cases (e.g. ultra reliable and low latency communication during user mobility).

A plurality of such predictions may be used in a weighted algorithm to determine a metric by which the source network node (e.g source gNB) is intelligently able to make a selection of a target network node (e.g. target gNB) which should serve a given UE to maintain consistent and seamless performance of this UE in the network.

As a corollary to the above, by making a comparison of the learnt behaviour of target network nodes (e.g. target gNBs), it may be easier to configure the target network nodes (e.g. target gNBs) to maintain similar network and/or UE performance in a given network area. This makes the network more robust against accidental scenarios wherein a network and/or a UE may have a dip in performance as a target network node (e.g. target gNB) is not aligned with another target network node (e.g. target gNB).

Such learnt behaviour may be used to assist standard network functions (e.g. load and admission control with artificial intelligence, machine learning and/or deep learning methods to improve real-time network) performance as the estimator of network transfer function is a function of time.

In case the source network node (e.g. source gNB) has multiple target network nodes (e.g. target gNBs) candidates for handover (obtained by checking a measurement report), the source network node (e.g. source gNB) may estimate the UE configuration at each target network node (e.g. target gNB) and make a more informed decision on the target network node (e.g. target gNB). The proposed solution has the following advantages over the prior-art solution where the source network node (e.g. source gNB) does not have any means to know the UE configuration at each target network node (e.g. target gNB) before performing the handover preparation (e.g. sending a handover request message and receiving a handover request acknowledge message containing the UE configuration at target network node (e.g. target gNB))

With the proposed solution, the source network node (e.g. source gNB) does not need to initiate the handover preparation for multiple candidate target network nodes (e.g. target gNBs) to obtain the corresponding UE configurations and make accordingly the target network nodes (e.g. target gNBs) selection. Thus, the proposed solution saves signaling overhead over Xn and the unnecessary resource reservations that are made by some target network nodes (e.g. target gNBs) candidates if they are not selected finally by the source network node (e.g. source gNB). For these target network nodes (e.g. target gNBs), the source network node (e.g. source gNB) has to send an additional handover cancel message to release the resource reservation which increases the signaling overhead even more.

With the proposed solution, the handover command is transmitted immediately by source gNB to UE (once source gNB receives the handover command from a target network node (e.g. target gNB)) which increases the likelihood that the handover is performed successfully by the UE. In the prior-art method, if the source network node (e.g. source gNB) initiates one target network node (e.g. target gNB) preparation at a time, the transmission of the handover command to the UE may be delayed. The source network node (e.g. source gNB) may have to re-initiate the handover preparation to another target cell which puts the handover at risk of failure.

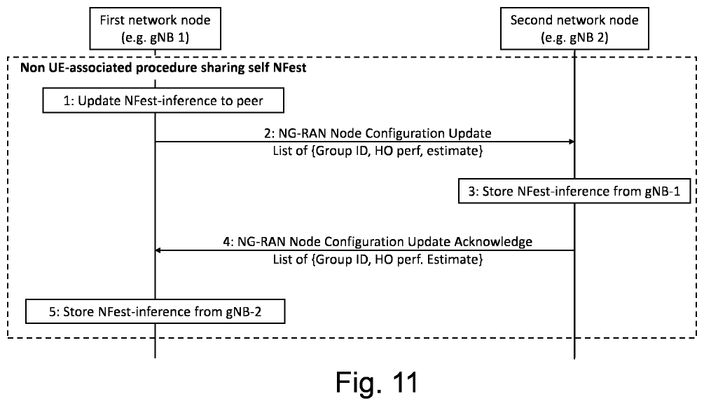

FIG. 11 shows a signalling diagram of a process for providing a prediction of a network and/or a group of UEs performance when a network procedure involving a source network node (e.g. source gNB) and a target network node (e.g. target gNB) is performed, wherein the process implements a push mechanism.

In step 1, a first network node or target network node (e.g. gNB-1) may update a prediction indicator. The prediction indicator appears in the figure as HO perf. estimate. The prediction indicator may indicate a network and/or a group of UEs performance when the group of UEs is handed over from a second network node or source network node (e.g. gNB-2) to the target network node (e.g. gNB-1). The target network node (e.g. gNB-1) may update the prediction indicator upon receiving an up-to-date model of the target network node (e.g. gNB-1) from the training host.

The prediction indicator may indicate a chance of success in the event that a UE in the group would be handed over from the source network node (e.g. source gNB) to the target network node (e.g. target gNB). The prediction indicator may comprise one or more value in the interval [0,1] for one or more key performance indicators (load and admission control, random access channel procedure or the like). The prediction indicator may comprise a joint value in the interval [0,1] for one or more key performance indicators (load and admission control, random access channel procedure or the like) and groups of UEs. The prediction indicator may comprise a binary value that indicate success or failure. The prediction indicator may comprise a soft value (a range of possible performances e.g., good, average, medium, bad or of a finer granularity). The soft value may be coupled by a time which may further indicate until when the prediction indicator will be valid (viewed by the source network node (e.g. source gNB) as a coherence time or a wait time).

The group of UEs may be grouped based on a network slice (e.g., enhanced mobile broadband or extended reality), based on UE capability, based on UE manufacturer assigned radio capability signalling (i.e. radio capability signalling ID), based on PLMN assigned radio capability signalling (i.e. radio capability signalling ID), based on UE models, based on UE vendors, based on location criteria or other.

In step 2, the target network node (e.g. gNB-1) may provide the prediction indicator to the source network node (e.g. gNB-2). The target network node (e.g. gNB-1) may provide the prediction indicator to the source network node (e.g. gNB-2) using non-UE associated signaling.

For example, the target network node (e.g. gNB-1) may re-use the NG-RAN node configuration update message (see TS 38.423). The NG-RAN node configuration update message may indicate the prediction indicator. The NG-RAN node configuration update message may indicate a group ID. The group ID may identify the group of UEs.

In step 3, the source network node (e.g. gNB-2) may store the prediction indicator along the group ID for future use. The source network node (e.g. gNB-2) may determine a different prediction indicator corresponding to the source network node (e.g. gNB-2). This prediction indicator may indicate the network and/or another group of UEs performance when another group of UEs is handed over from the target network node (e.g. gNB-1) to the source network node (e.g. gNB-2).

In step 4, the source network node (e.g. gNB-2) may provide the other prediction indicator to the target network node (e.g. gNB-1). The source network node (e.g. gNB-2) may provide the prediction indicator to the target network node (e.g. gNB-1) using non-UE associated signaling.

For example, the target network node (e.g. gNB-1) may re-use the NG-RAN node configuration update acknowledge message (see TS 38.423). The NG-RAN node configuration update acknowledge message may indicate the other prediction indicator. The NG-RAN node configuration update message may indicate another group ID. The other group ID may identify the other group of UEs.

Such reciprocal mechanism may be useful in the event that handover can take place in both directions between the source network node (e.g. gNB 2) and the target network node (e.g. gNB 1). Note that reuse of NG-RAN Node Configuration Update may be optional and a new message can be introduced instead.

By reusing NG-RAN Node Configuration Update neighbouring NG-RAN nodes can push to each other prediction indicators indicating a network and/or a group of UEs performance when the group of UEs is handed over from a second network node or source network node (e.g. gNB-2) to the target network node (e.g. gNB-1) or vice versa.

It will be understood that although a push mechanism has been described, a pull mechanism may be contemplated as well. Such pull mechanism may allow a network node to obtain prediction indicators on demand. This can be done either in one-shot request or in a periodic fashion.

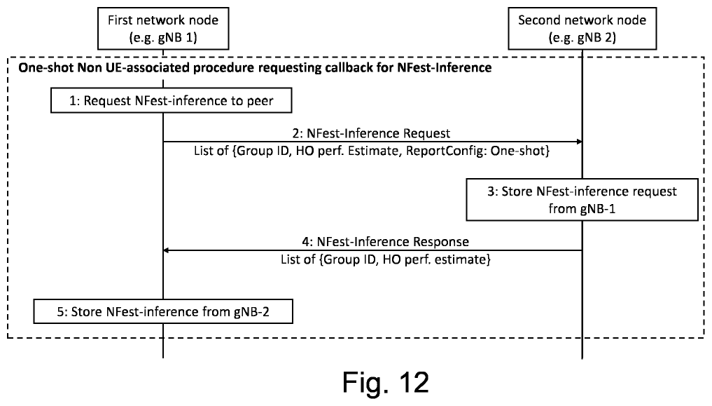

FIG. 12 shows a signalling diagram of a process for providing a prediction of a network and/or a group of UEs performance when a network procedure involving a source network node (e.g. source gNB) and a target network node (e.g. target gNB) is performed, wherein the process implements a one short pull mechanism.

The method of FIG. 12 differs from the method of FIG. 11 in that the source network node (e.g. gNB-2) may provide the other prediction indicator to the target network node (e.g. gNB-1) once in step 4 in response to a one-shot pull request in step 2. The prediction indicator appears in the figure as HO perf. estimate.

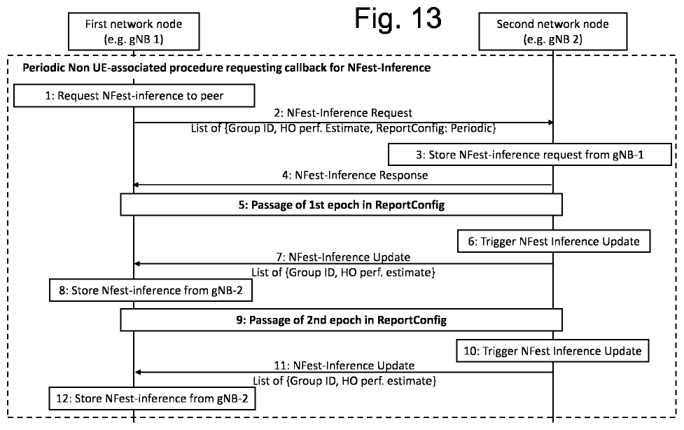

FIG. 13 shows a signalling diagram of a process for providing a prediction of a network and/or a group of UEs performance when a network procedure involving a source network node (e.g. source gNB) and a target network node (e.g. target gNB) is performed, wherein the process implements a periodic pull mechanism.

The method of FIG. 13 differs from the method of FIG. 11 in that the source network node (e.g. gNB-2) may provide the other prediction indicator to the target network node (e.g. gNB-1) periodically in steps 4, 7 and 11 in response to a periodic pull request in step 2. The prediction indicator appears in the figure as HO perf. estimate.

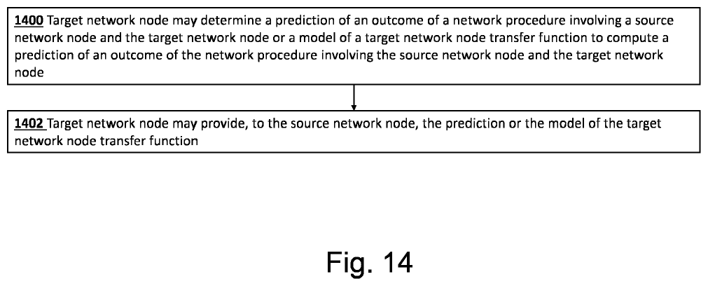

FIG. 14 shows a block diagram of a method for providing a prediction or a model NFₑₛₜ of a target network node transfer function to compute a prediction. The method may be performed by a target network node (e.g. target gNB).

In step 1100, a target network node may determine a prediction of an outcome of a network procedure involving a source network node and the target network node or a model of a target network node transfer function to compute a prediction of an outcome of the network procedure involving the source network node and the target network node.

In step 1102, the target network node may provide, to the source network node, the prediction or the model of the target network node transfer function.

Determining the prediction or a model of a target network node transfer function may be in response to: receiving, from the source network node, a request to provide a prediction or a model of a target network node transfer function; and/or receiving, from a training host, a prediction or a model of a target network node transfer function.

The network procedure involving the source network node and the target network node may a handover procedure; or the network procedure involving the source network node and the target network node may be a dual connectivity procedure.

The target network node may receive, from the source network node, a request to prepare the network procedure involving the source network node and the target network node.

The request to prepare the network procedure involving the source network node and the target network node may comprise the request to provide a prediction or a model of a target network node transfer function.

The target network node may provide, to the source network node, a response to the request to prepare the network procedure involving the source network node and the target network node.

The response to the request to prepare the network procedure involving the source network node and the target network node may comprise at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The target network node may send, to a training host, a request to provide the model of the target network node transfer function. The target network node may receive, from the training host, the model of the target network node transfer function.

The training host may be part of the target network node or separate from the target network node.

The training host may be configured to compute the model of the target network node transfer function based on user equipment capability received by the target training node and user equipment configuration generated by the target training node over time; and/or the training host may use a deep neural network.

The target network node may determine that the prediction or the model of the target network node transfer function is no longer up to date. The target network node may provide, to the source network node, an up-to-date prediction or model of the target network node transfer function.

The prediction or the model of the target network node transfer function may be for a single user equipment or for a group of user equipments or for a plurality of groups of user equipments.

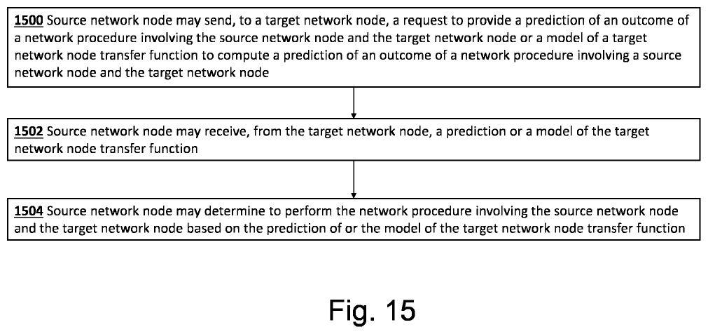

FIG. 15 shows a block diagram of a method for providing a prediction or a model NFₑₛₜ of a target network node transfer function to compute a prediction and for using the prediction or the model NFₑₛₜ of a target network node transfer function to compute a prediction. The method may be performed by a target network node (e.g. target gNB).

The source network node may send, to a target network node, a request to provide a prediction of an outcome of a network procedure involving the source network node and the target network node or a model of a target network node transfer function to compute a prediction of an outcome of a network procedure involving a source network node and the target network node.

The source network node may receive, from the target network node, a prediction or a model of the target network node transfer function.

The source network node may determine to perform the network procedure involving the source network node and the target network node based on the prediction of or the model of the target network node transfer function.

The source network node may store, the prediction or a model of the target network node transfer function.

The network procedure involving the source network node and the target network node may be a handover procedure; or the network procedure involving the source network node and the target network node may be a dual connectivity procedure.

The source network node may send, to the target network node, a request to prepare the network procedure involving the source network node and the target network node.

The request to prepare the network procedure involving the source network node and the target network node may comprise a request to provide the prediction or the model of the target network node transfer function.

The source network node may receive, from the target network node, a response to the request to prepare the network procedure involving the source network node and the target network node.

The response to the request to prepare the network procedure involving the source network node and the target network node may comprises at least one of the prediction, the model of the target network node transfer function, a level of confidence or reliability of the prediction or the model of the target network node transfer function or an indication that the prediction or the model of the target network node transfer function is only valid for some user equipment configuration or an indication that the prediction or the model of the target network node transfer function is only valid for a given period of time.

The source network node may receive, from the target network node, an up-to-date prediction or an up-to-date model of the target network node transfer function.

Determining to prepare the network procedure involving the source network node and the target network node based on the model of the target network node transfer function may comprise: receiving, from a user equipment, user equipment capability; determining a prediction of an outcome of network procedure involving a source network node and the target network node based on the model of the target network node transfer function; and determining to perform the network procedure involving the source network node and the target network node based on the prediction.

The source network node may send, to the target network node, a request to prepare the network procedure involving the source network node and the target network node. The request to prepare the network procedure involving the source network node and the target network node comprises an identifier of the prediction or the model of the target network node transfer function.

The source network node may provide, to the target network node, a subsequent prediction of an outcome of another network procedure involving the source network node and the target network node or a model of the target network node transfer function to compute a subsequent prediction of an outcome of another network procedure involving the source network node and the target network node.

Providing, to the target network node, the prediction or the model of the source network node transfer function may be in response to: receiving, from the target network node, the prediction or the model of the target network node transfer function; receiving, from the target network node, a one-shot pull request to provide the subsequent prediction or the model of the source network node transfer function; or receiving, from the target network node, a periodic pull request to provide the subsequent prediction or the model of the source network node transfer function.

The prediction indicator may comprise at least one of one or more values in an interval [0,1] for one or more key performance indicators, a joint value in an interval [0,1] for one or more key performance indicators, a binary value that indicates success or failure, a soft value or a time indicating until when the prediction indicator will be valid.

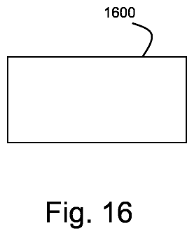

FIG. 16 shows a schematic representation of a non-volatile memory medium 1600 storing instructions and/or parameters which when executed by a processor allow the processor to perform one or more of the steps of the methods of FIGS. 14 and 15.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 14 and 15, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1.-15. (canceled)

16. A source network device comprising:
a processor; and
a non-transitory computer-readable medium comprising computer-executable instructions that when executed by the processor, cause the processor to perform the following operations:
prior to knowing a configuration of a user equipment configuration at a first target network device and a second target network device and prior to sending a handover request to either of the first target network device and the second target network device:
receive a measurement report from a user equipment;
based on the measurement report, identify the first target network device and the second target network device as candidates for a handover of the user equipment;
request, from the first target network device, a first target network transfer function generated based on user equipment capability received by the first target network transfer function and user equipment configuration generated over time;
request, from the second target network device, a second target network transfer function generated based on user equipment capability received by the second target network transfer function and user equipment configuration generated over time;
predict, using the first target network transfer function, a first user equipment configuration to be used by the user equipment in an event the user equipment is handed over to the first target network device;
predict, using the second target network transfer function, a second user equipment configuration to be used by the user equipment in an event the user equipment is handed over to the second target network device;
compare the first user equipment configuration to the second user equipment configuration;
based on the comparing, determine that an experience of the user equipment would be less impacted in the event that the user equipment would be handed over from the source network device to the second target network device rather than in the event that the user equipment would be handed over from the source network device to the first target network device as a result of the second target network device admitting all packet data unit (PDU) sessions whereas the first target network device would drop a PDU session;
based on the determining, send a handover request to the second target network device without sending the handover request to the first target network device, the handover request comprising: an identifier of the user equipment, the second user equipment configuration, the user equipment capability, an identifier of the second target network transfer function;
receive, from the second target network device, acknowledgment of the handover request; and
based on receiving the acknowledgement of the handover request, execute the handover of the user equipment from the source network device to the second target network device.

17. The source network device of claim 16, wherein the computer-executable instructions further cause the processor to send, to the first target network device and the second target network device, a request to prepare a network procedure involving the source network device and the first target network device and the second target network device, respectively.

18. The source network device of claim 17, wherein the request to prepare the network procedure involving the first target network device and the second target network device comprises the request to provide information to perform a prediction of the user equipment configuration.

19. The source network device of claim 18, wherein the computer-executable instructions further cause the processor to receive, from each of the first target network device and the second target network device, a response to the request to prepare the network procedure.

20. The source network device of claim 19, wherein the response to the request to prepare the network procedure comprises the following: a respective target network transfer function, a level of confidence or reliability of the model of the respective target network transfer function; an indication that the model of the respective target network transfer function is only valid for some user equipment configuration; and an indication that the model of the respective target network transfer function is only valid for a given period of time.

21. The source network device of claim 20, wherein the model of the respective target network transfer function is generated by a training host separate from each of the first target network device and the second target network device.

22. The source network device of claim 21 wherein the computer-executable instructions further cause the processor to:
determine that each of the first target network transfer function and the second target network transfer function are no longer up to date; and
receive, from each of the first target network device and the second target network device, an up-to-date version of each of the first target network transfer function and the second target network transfer function.

23. A system comprising:
a first target network device;
a second target network device;
a source network device comprising:
a processor; and
a non-transitory computer-readable medium comprising computer-executable instructions that when executed by the processor, cause the processor to perform the following operations:
prior to knowing a configuration of a user equipment configuration at the first target network device and the second target network device and prior to sending a handover request to either of the first target network device and the second target network device:
receive a measurement report from a user equipment;
based on the measurement report, identify a first target network device and a second target network device as candidates for a handover of the user equipment;
request, from the first target network device, a first target network transfer function generated based on user equipment capability received by the first target network transfer function and user equipment configuration generated over time;
request, from the second target network device, a second target network transfer function generated based on user equipment capability received by the second target network transfer function and user equipment configuration generated over time;
predict, using the first target network transfer function, a first user equipment configuration to be used by the user equipment in an event the user equipment is handed over to the first target network device;
predict, using the second target network transfer function, a second user equipment configuration to be used by the user equipment in an event the user equipment is handed over to the second target network device;
compare the first user equipment configuration to the second user equipment configuration;
based on the comparing, determine that an experience of the user equipment would be less impacted in the event that the user equipment would be handed over from the source network device to the second target network device rather than in the event that the user equipment would be handed over from the source network device to the first target network device as a result of the second target network device admitting all packet data unit (PDU) sessions whereas the first target network device would drop a PDU session;
based on the determining, send a handover request to the second target network device without sending the handover request to the first target network device, the handover request comprising: an identifier of the user equipment, the second user equipment configuration, the user equipment capability, an identifier of the second target network transfer function;
receive, from the second target network device, acknowledgment of the handover request; and
based on receiving the acknowledgement of the handover request, execute the handover of the user equipment from the source network device to the second target network device.

24. The system of claim 23, wherein the computer-executable instructions further cause the processor to send, to the first target network device and the second target network device, a request to prepare a network procedure involving the source network device and the first target network device and the second target network device, respectively.

25. The system of claim 24, wherein the request to prepare the network procedure involving the first target network device and the second target network device comprises the request to provide information to perform a prediction of the user equipment configuration.

26. The system of claim 25, wherein the computer-executable instructions further cause the processor to receive, from each of the first target network device and the second target network device, a response to the request to prepare the network procedure.

27. The system of claim 26, wherein the response to the request to prepare the network procedure comprises the following: a respective target network transfer function, a level of confidence or reliability of the model of the respective target network transfer function; an indication that the model of the respective target network transfer function is only valid for some user equipment configuration; and an indication that the model of the respective target network transfer function is only valid for a given period of time.

28. The system of claim 27, wherein the model of the respective target network transfer function is generated by a training host separate from each of the first target network device and the second target network device.

29. A method comprising:
prior to knowing a configuration of a user equipment configuration at a first target network device and a second target network device and prior to sending a handover request to either of the first target network device and the second target network device:
receiving a measurement report from a user equipment;
based on the measurement report, identifying a first target network device and a second target network device as candidates for a handover of the user equipment;
requesting, from the first target network device, a first target network transfer function generated based on user equipment capability received by the first target network transfer function and user equipment configuration generated over time;
requesting, from the second target network device, a second target network transfer function generated based on user equipment capability received by the second target network transfer function and user equipment configuration generated over time;
predicting, using the first target network transfer function, a first user equipment configuration to be used by the user equipment in an event the user equipment is handed over to the first target network device;
predicting, using the second target network transfer function, a second user equipment configuration to be used by the user equipment in an event the user equipment is handed over to the second target network device;
comparing the first user equipment configuration to the second user equipment configuration;
based on the comparing, determining that an experience of the user equipment would be less impacted in the event that the user equipment would be handed over from the source network device to the second target network device rather than in the event that the user equipment would be handed over from the source network device to the first target network device as a result of the second target network device admitting all packet data unit (PDU) sessions whereas the first target network device would drop a PDU session;
based on the determining, sending a handover request to the second target network device without sending the handover request to the first target network device, the handover request comprising: an identifier of the user equipment, the second user equipment configuration, the user equipment capability, an identifier of the second target network transfer function;
receiving, from the second target network device, acknowledgment of the handover request; and
based on receiving the acknowledgement of the handover request, executing the handover of the user equipment from the source network device to the second target network device.

30. The method of claim 29, further comprising sending, to the first target network device and the second target network device, a request to prepare a network procedure involving the source network device and the first target network device and the second target network device, respectively.

31. The method of claim 30, wherein the request to prepare the network procedure involving the first target network device and the second target network device comprises the request to provide information to perform a prediction of the user equipment configuration.

32. The method of claim 31, further comprising receiving, from each of the first target network device and the second target network device, a response to the request to prepare the network procedure.

33. The method of claim 33, wherein the response to the request to prepare the network procedure comprises the following: a respective target network transfer function, a level of confidence or reliability of the model of the respective target network transfer function; an indication that the model of the respective target network transfer function is only valid for some user equipment configuration; and an indication that the model of the respective target network transfer function is only valid for a given period of time.

34. The method of claim 20, wherein the model of the respective target network transfer function is generated by a training host separate from each of the first target network device and the second target network device.

35. The method of claim 34, further comprising:
determining that each of the first target network transfer function and the second target network transfer function are no longer up to date; and
receiving, from each of the first target network device and the second target network device, an up-to-date version of each of the first target network transfer function and the second target network transfer function.
